(19) United States
(12) Patent Application Publication
(10) Pub. No.: US 2022/0403056 A1
(43) Pub. Date: Dec. 22, 2022

(54) CURED RUBBER NETWORK WITH COVALENT AND HYDROGEN-BONDED CROSSLINKS

(71) Applicant: Bridgestone Corporation, Tokyo (JP)

(72) Inventors: Erin SHEEPWASH, Copley, OH (US); Walter A. SALAMANT, Akron, OH (US); Paul N. HAMILTON, New Franklin, OH (US)

(21) Appl. No.: 17/777,184

(22) PCT Filed: Nov. 16, 2020
(86) PCT No.: PCT/US2020/060795

§ 371 Date: May 16, 2022

Related U.S. Application Data
(60) Provisional application No. 62/935,756, filed on Nov. 15, 2019.

(51) Int. Cl. C08C 19/20; C08F 236/10; C08C 19/22; C08K 3/36

(52) U.S. Cl. CPC C08C 19/20; C08F 236/10; C08C 19/22; C08K 3/36

(57) ABSTRACT

A vulcanizate is provided that includes a crosslinked network of elastomeric polymer having hydrogen bonds and covalent bonds. A method for preparing a functionalized elastomeric polymer and a method for preparing the vulcanizate are also provided.

This application claims the benefit of U.S. Provisional Application Ser. No. 62/935,756 filed on Nov. 15, 2019, which is incorporated herein by reference.

### FIELD OF THE INVENTION

Embodiments of the invention are directed toward cured rubber compositions having hydrogen-bonded crosslinks and covalently-bonded crosslinks.

### BACKGROUND OF THE INVENTION

Hydrogen bonding is an attractive interaction between a hydrogen atom from a molecule or molecular fragment H-X (the hydrogen bond donor), in which X is more electronegative than H, and an atom or a group of atoms in the same or a different molecule (the hydrogen bond acceptor), bearing a lone pair of electrons. Depending on the nature of the donor and acceptor, their geometry, and environment, the energy of the hydrogen bond can vary between about 1 and 40 kilocalories per mole (kcal/mol). Hydrogen bonds are generally weaker than covalent and ionic bonds.

In cured rubber systems, crosslinking of the polymer molecules provides improvement in mechanical properties such as hardness, static and dynamic modulus, tensile and tear strength, toughness, and fatigue life. Conventional crosslinking is accomplished via covalent and/or ionic bonds. When the cured rubber system is exposed to deformation forces, bonds may rupture as a reaction to relieve stress and dissipate energy in the form of heat. Fillers, such as carbon black and silica, allow dissipation of energy via breakage of the filler network and sliding friction between rubber and filler particles. Irreversible breakage of the crosslinks and/or filler network may lead to degradation of mechanical properties and cracking. Compositions having improved properties are desired.

### SUMMARY OF THE INVENTION

One or more embodiments of the present invention provide a vulcanizate composition comprising a crosslinked network of elastomeric polymer, where the crosslinked network includes hydrogen bonds and covalent bonds.

Other embodiments of the present invention provides a method for forming a functionalized elastomeric polymer having pendant functional groups that are capable of forming hydrogen bonds, the method comprising the steps of combining an elastomeric polymer and an enophilic functionalizing agent, where the enophilic functionalizing agent includes (i) at least one group that is capable of forming a covalent bond with the elastomeric polymer, and (ii) at least one moiety that is capable of forming a hydrogen bond, to thereby react the elastomeric polymer and the enophilic functionalizing agent.

Still other embodiments of the present invention provides a method for preparing a vulcanizate, the method comprising the steps of (i) providing a functionalized elastomeric polymer having pendant functional groups that are capable of forming hydrogen bonds; (ii) combining the functionalized elastomeric polymer with filler and a curative to form a vulcanizable composition, and (iii) curing the vulcanizable composition to form a crosslinked network that includes hydrogen bonds and covalent bonds.

Yet other embodiments of the present invention provide a method for preparing a vulcanizate, the method comprising (i) combining an elastomeric polymer, silica, and a silica functionalizing agent, where the silica functionalizing agent includes a hydrolyzable group and a hydrogen-bonding group; (ii) mixing the elastomeric polymer, silica, and silica functionalizing agent to form a mixture; (iii) introducing a curative to the mixture to form a vulcanizable composition of matter; and (iv) subjecting the vulcanizable composition to curing conditions to form a vulcanizate.

Other embodiments of the present invention provide an elastomeric vulcanizate comprising a crosslinked elastomeric network and silica filler dispersed within the network, where the silica includes at least two silica particles bonded via a hydrogen-bonded bridging group.

### BRIEF DESCRIPTION OF THE DRAWINGS

FIG. 1 is a schematic representation of hydrogen-bonded polymer chains according to aspects of the invention.

FIG. 2 is a schematic representation of a self-assembled polymeric network according to aspects of the invention.

FIG. 3A is a formulaic representation of an elastomeric polymer hydrogen bonded to a silica particle according to aspects of the invention.

FIG. 3B is a formulaic representation of two silica particles hydrogen bonded to each other according to aspects of the invention.

### DETAILED DESCRIPTION OF ILLUSTRATIVE EMBODIMENTS

Embodiments of the invention are based, at least in part, on the discovery of a crosslinked network of elastomeric polymers, where the crosslinked network includes intermolecular bonds through hydrogen bonding and covalent bonding. In one or more embodiments, the crosslinked polymer network includes a plurality of diene-based polymer chains that are intermolecularly bonded through both covalent-bridging groups and hydrogen-bonded bridging groups. In one or more embodiments, the crosslinked polymer network is prepared from a vulcanizable composition including an elastomeric polymer including hydrogen-bonding functionalities that interact to form the intermolecular hydrogen bonds. In one or more embodiments, the polymers including the hydrogen-bonding functionalities are advantageously prepared in solution, isolated, and then combined with other constituents to form a vulcanizable composition. In one or more embodiments, the crosslinked elastomeric network is a component of a reinforced rubber vulcanizate.

Other embodiments are based, at least in part, on the discovery of crosslinked elastomeric networks including silica filler that is bonded to the crosslinked network and/or to other silica particles through hydrogen bonding. According to one or more embodiments, the silica is modified to include hydrogen bonding functionalities by reacting the silica with a functionalizing agent. This functionalization reaction can advantageously take place in the presence of the elastomeric polymer or prior to introducing the silica to the elastomeric polymer.

### Characteristics of Crosslinked Network

In one or more embodiments, the cured rubber compositions of the invention may be characterized by crosslink density and one or more subcomponents of crosslink density such as the amount of crosslink density contributed by hydrogen bonding. As those skilled in the art appreciate, crosslink density may be calculated by the Flory-Rehner equation, which is

$${v}_{e} \frac{( χ {v}_{r}^{2} + ln ( 1 - {v}_{r} ) + {v}_{r} )}{{V}_{o} ( 0.5 {v}_{r} - {v}_{r}^{1 / 3} )}$$

where Vₑ is the crosslink density, Vᵣ is the equilibrium volume fraction of the rubber in the swollen state, V₀ is the molar volume of the solvent, and χ is the polymer-solvent interaction parameter.

As those skilled in the art appreciate, the equilibrium volume fraction of the rubber in the swollen state (Vᵣ) can be calculated from the following equation

$${v}_{r} = \frac{1}{1 + \frac{{d}_{r}}{{d}_{s}} ( \frac{1 - {f}_{sol}}{1 - {f}_{sol} - {f}_{fil}} ) ( \frac{{W}_{S}}{{W}_{D}} - 1 )}$$

where dᵣ is density of the rubber, d_{S} is the density of the solvent, fₛₒₗ is the weight fraction of soluble material, f_{fil} is the initial weight fraction of the filler, W_{S} is the weight of the solvent swollen rubber sample, and W_{D} is the weight of the dried rubber sample. Solvent swelling of the rubber sample can take place in toluene at room temperature according to ASTM D471. The techniques for determining crosslink density through these equations is fully explained in Use Of χ As A Function Of Volume Fraction Of Rubber To Determine Crosslink Density By Swelling, RUBBER CHEMISTRY AND TECHNOLOGY, 2003, 76, 4, 832-845, which is incorporated herein by reference.

The rubber compositions of the present invention are characterized by a total crosslink density (Vₑ-total), which may include crosslinks from covalent networks, hydrogen bonding, entanglements, and filler interactions. In one or more embodiments, the rubber compositions are characterized by a total crosslink density of greater than 1E-6, in other embodiments greater than 5E-6, and in other embodiments greater than 1E-5. In these or other embodiments, rubber compositions are characterized by a total crosslink density of less than 5E-3, in other embodiments less than 1E-3, and in other embodiments less than 5E-4. In one or more embodiments, rubber compositions are characterized by a total crosslink density of from about 1E-6 to about 5E-3, in other embodiments from about 5E-6 to about 1E-3, and in other embodiments from about 1E-5 to about 5E-4.

The rubber compositions of the present invention are characterized by the crosslink density (Vₑ—H-bond) that is attributed to hydrogen bonding, where Vₑ—H-bond is determined in a corresponding manner to Vₑ-total. As the skilled person will appreciate, the amount of crosslinks attributed to hydrogen bonding can be determined experimentally by determining the total crosslink density of a first sample prepared with polymer having hydrogen bonding groups and comparing the total crosslink density of that first sample to that of a second sample that is otherwise identical except for the absence of the hydrogen bonding groups. In one or more embodiments, the rubber compositions are characterized by a crosslink density attributed to hydrogen bonding of greater than 1E-7, in other embodiments greater than 5E-7, and in other embodiments greater than 1E-6. In these or other embodiments, rubber compositions are characterized by a crosslink density attributed to hydrogen bonding of less than 5E-5, in other embodiments less than 1E-5, and in other embodiments less than 5E-6. In one or more embodiments, rubber compositions are characterized by a crosslink density attributed to hydrogen bonding of from about 1E-7 to about 5E-6, in other embodiments from about 5E-7 to about 1E-5, and in other embodiments from about 1E-6 to about 5E-6.

In one or more embodiments, the rubber compositions of the present invention can be characterized by percentage of crosslink density attributed to hydrogen bonding relative to the total crosslink density. In one or more embodiments, greater than 0.1%, in other embodiments greater than 0.5%, and in other embodiments greater than 1.0% of the total crosslink density is attributed to hydrogen bonding. In these or other embodiments, less than 50%, in other embodiments less than 30%, in other embodiments less than 20%, in other embodiments less than 10%, in other embodiments less than 5%, in other embodiments less than 3%, and in other embodiments less than 2% of the total crosslink density is attributed to hydrogen bonding. In one or more embodiments, from about 0.1 to about 50%, in other embodiments from about 0.5 to about 30%, and in other embodiments from about 1 to about 20% of the total crosslink density is attributed to hydrogen bonding.

### Covalently-Bonded Bridging Groups

As indicated above, the crosslinked networks of elastomeric polymers of the invention include intermolecular bonds that include covalent bonds, which may be referred to as covalently-bonded bridging groups (i.e. crosslinks). These bridging groups include an atom or a covalently-bonded group of atoms that is covalently bonded to at least two polymer chains. Thus, the bridging group provides a bridge, or connection, between the polymer chains. In one or more embodiments, the covalently-bonded bridging groups include conventional crosslinking groups of the type that are formed via sulfur cure of diene polymers. For example, the covalently-bonded bridging group may include a group of sulfur atoms in a short chain, a single sulfur atom, a carbon-to-carbon bond, or heteroatom-containing covalent bonds. Typical sulfur-cured polymer networks are described, for example, in Stephens H. L. (1987). The Compounding and Vulcanization of Rubber. In: Morton M. (eds) Rubber Technology. Springer, Boston, Mass.; Kirk-Othmer, Encyclopedia of Chemical Technology, 365-468, (3RD Ed. 1982), particularly Vulcanization Agents and Auxiliary Materials, 390-402, and A. Y. Coran, Vulcanization in Encyclopedia of Polymer Science and Engineering, (2ND Ed. 1989), all of which are incorporated herein by reference. In one or more embodiments, the covalent bonds may also exist between polymer and filler, such as when a silica coupling agent is employed with silica filler.

### Hydrogen-Bonded Bridging Groups

As indicated above, the crosslinked networks of elastomeric polymers of the invention may also include intermolecular bonds that include hydrogen bonds, which may be referred to as hydrogen-bonded bridging groups. These bridging groups include atoms, or groups of atoms, on different polymer chains that are connected by a pair of hydrogen bonding groups (i.e. connected by hydrogen interaction). In one or more embodiments, the atoms or groups of atoms that form the hydrogen bonding interaction are covalently bonded to different polymer chains. Stated differently, the bridging groups are formed by hydrogen bonding interaction between two complementary hydrogen-bonding functionalities or groups. It should be appreciated that these hydrogen-bonded bridging groups may exist between polymer chains when functionalized polymers are employed. In other embodiments, where both functionalized polymer and modified filler is employed, these hydrogen-bonded bridging groups exist between polymer and silica filler. Or, in one or more embodiments, they may exist between modified silica particles.

In one or more embodiments, the hydrogen-bonded bridging group includes multiple hydrogen bonds. In one or more embodiments, the hydrogen-bonded bridging group includes a series of two, three, or four hydrogen bonds. In particular embodiments, the bridging group includes a linear array of hydrogen bonds. Linear arrays of hydrogen bonded systems are further described in Sijbesma, R. P. et al., “Quadruple Hydrogen Bonded Systems,” Chem. Commun. 2003, 5-16, and van der Mee, M. A. J., “Thermoreversible Cross-linking of Elastomers,” Eindhoven U. of Tech, Dutch Polymer Institute, Project #346, 2007, both of which are incorporated by reference herein.

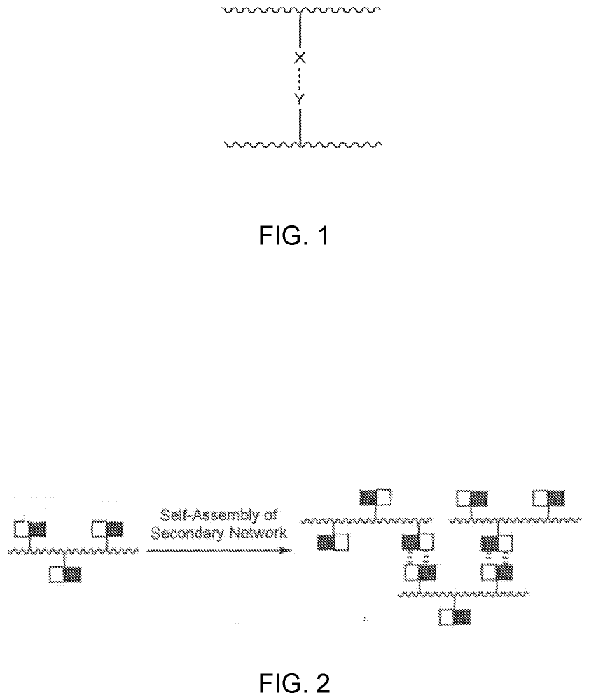

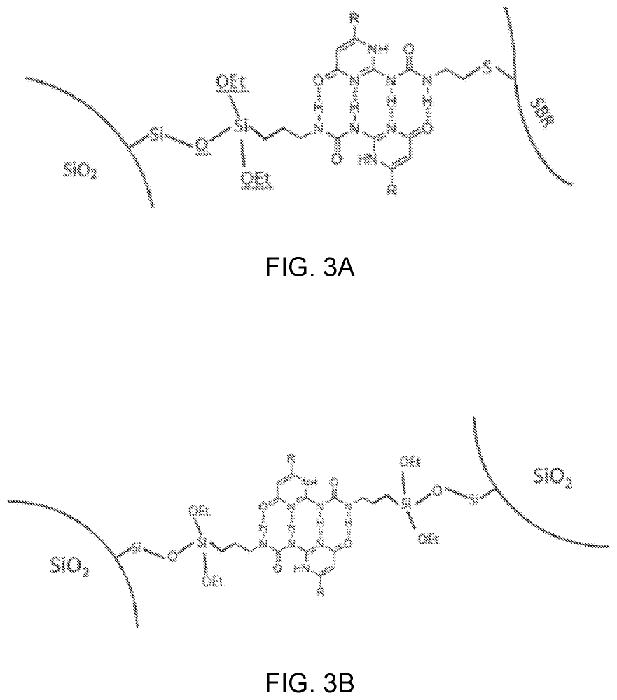

In or more embodiments, the hydrogen-bonded bridging groups may be described with reference to FIG. 1, which shows two polymer chains hydrogen bonded to each other through substituents X and Y. X is covalently bonded to the first polymer chain [symbol] , Y is covalently bonded to the second polymer chain [symbol] , and X and Y are hydrogen bonded [symbol] to each other. X and Y may be the same or different. In one or more embodiments, each X and Y are hydrogen bonded at two or more hydrogen-bonding sites (i.e. two separate hydrogen bonds exist between X and Y), in other embodiments, each X and Y are hydrogen bonded at three or more hydrogen-bonding sites, and in other embodiments, each X and Y are hydrogen bonded at four hydrogen-bonding sites.

The hydrogen-bonded bridging groups can be characterized by a binding constant (k). As those skilled in the art understand, a binding constant can be experimentally derived by determining the relative concentration of the hydrogen-bonded chains relative to the concentration of the unbound polymer chains within a solution of solvent with low polarity (e.g. toluene or hexane) at a given temperature. In one or more embodiments, the binding constant of the hydrogen-bonded groups is greater than 1E3/M, in other embodiments greater than 1E4/M, and in other embodiments greater than 1E5/M. In these or other embodiments, the binding constant of the hydrogen-bonded groups is from about 1E3/M to about 1E10/M, in other embodiments from about 1E4/M to about 1E9/M, and in other embodiments from about 1E5/M to about 1E8/M.

Polymers with Hydrogen-Bonding Functionalities

As suggested above, the polymer networks of the present invention derive from crosslinking a plurality of polymers including polymers having a hydrogen-bonding functionality. For purposes of this specification, these polymers may be referred to as functionalized polymers. In one or more embodiments, these hydrogen-bonding functionalities are non-terminal functionalities (i.e. they are pendent to the backbone of the polymer chain). In one or more embodiments, the functionalized polymers of this invention are devoid of terminal functionality.

### Polymer Chains

In one or more embodiments, the functionalized polymers of this invention include a polymer chain (i.e. backbone) and at least one hydrogen-bonding functionality attached to the chain.

In one or more embodiments, the polymer chain may include a synthetic or natural polymer (e.g. natural rubber). In one or more embodiments, the polymer chain, which may also be referred to as an elastomeric polymer chain, includes a polymer that is capable of being crosslinked (i.e. cured or vulcanized) to form an elastomeric composition of matter. In one or more embodiments, the polymer chain is unsaturated. In one or more embodiments, the synthetic polymers may include diene-based elastomeric polymers. In one or more embodiments, the elastomeric polymers are linear molecules. In other embodiments, the elastomeric polymers are substantially linear or only include limited branching.

In one or more embodiments, the synthetic elastomeric polymers, which may simply be referred to as elastomers, may derive from the polymerization of conjugated diene monomers, optionally together with monomer copolymerizable therewith. Useful diene monomers include, but are not limited to, 1,3-butadiene and isoprene. Exemplary monomers that may be copolymerized with dienes include, but are not limited, vinyl aromatics such as styrene. Other rubbery elastomers may derive from the polymerization of ethylene together with one or more alpha-olefins and optionally one or more diene monomers. Examples of synthetic elastomers include, but are not limited to, synthetic polyisoprene, polybutadiene, polyisobutylene-co-isoprene, neoprene, poly(ethylene-co-propylene), poly(styrene-co-butadiene), poly(styrene-co-isoprene), and poly(styrene-co-isoprene-co-butadiene), poly(isoprene-co-butadiene), poly(ethylene-co-propylene-co-diene), polysulfide rubber, acrylic rubber, urethane rubber, silicone rubber, epichlorohydrin rubber, and mixtures thereof. In particular embodiments, the elastomers include a random copolymer of butadiene, styrene, and optionally isoprene. In other embodiments, the elastomer is a block copolymer of polybutadiene, polystyrene, and optionally polyisoprene. In particular embodiments, the elastomer is hydrogenated or partially hydrogenated.

In one or more embodiments, the polymer chains may be characterized by a glass transition temperature (Tg) of less than 0° C., in other embodiments less than −20° C., and in other embodiments less than −30° C. In one or more embodiments, the polymer chains may be characterized by Tg of from about 0 to about −115° C., in other embodiments from about −20 to about −100° C., and in other embodiments from about −30 to about −70° C.

In one or more embodiments, the polymer chains, prior to being crosslinked, may have a number average molecular weight (Mn) of greater than 30 kg/mol, in other embodiments greater than 75 kg/mol, in other embodiments greater than 100 kg/mol. In these or other embodiments, the polymer chains, prior crosslinking, may have an Mn of less than 500 kg/mol, in other embodiments less than 300 kg/mol, and in other embodiments less than 150 kg/mol. In one more embodiments, the polymer chains, prior to being crosslinked, may have a molecular weight of from about 30 to about 500, in other embodiments from about 75 to about 300, and in other embodiments from about 100 to about 250 kg/mol. In one or more embodiments, the polymers, prior to crosslinking, may be characterized by a molecular weight distribution (Mn/Mw) of less than 5.5, in other embodiments less than 4.0, and in other embodiments less than 2.5. As is known in the art, Mn (number average molecular weight) and Mw (weight average molecular weight) may be determined by using gel permeation chromatography (GPC) calibrated with polystyrene standards and adjusted for the Mark-Houwink constants for the polymer in question.

In one or more embodiments, the polymer chain is a homopolymer, and in other embodiments the polymer chain is a copolymer, which refers to a polymer having two or more chemically distinct mer units. In one or more embodiments, the mer units of the polymer derived from diene may have a cis, trans, or vinyl microstructure.

In one or more embodiments, the polymer chain may be a polydiene having a high cis-1,4-linkage, including those high cis polymers prepared by coordination catalysis. In one or more embodiments, the cis-1,4-linkage content may be greater than about 70%, in other embodiments greater than about 90%, and in other embodiments greater than about 95%. Also, these polymers may have a 1,2-linkage content (i.e., vinyl content) that is less than about 7%, in other embodiments less than 2%, and in other embodiments less than 1%. The cis-1,4- and 1,2-linkage contents can be determined by infrared spectroscopy.

In one or more embodiments, the polymer chain is a medium or low cis polydiene (or polydiene copolymer) including those prepared by anionic polymerization techniques. These polydienes can have a cis content of from about 10% to about 70%, in other embodiments from about 15% to about 60%, and in other embodiments from about 20% to about 50%, where the percentages are based upon the number of diene mer units in the cis configuration versus the total number of diene mer units. These polydienes may also have a 1,2-linkage content (i.e., vinyl content) from about 10% to about 60%, in other embodiments from about 15% to about 50%, and in other embodiments from about 20% to about 45%, where the percentages are based upon the number of diene mer units in the vinyl configuration versus the total number of diene mer units. The balance of the diene units may be in the trans-1,4-linkage configuration.

In one or more embodiments, the polymer chain is a copolymer wherein less than 70%, in other embodiments less than 50%, in other embodiments less than 30%, in other embodiments less than 28%, in other embodiments less than 26%, in other embodiments less than 24%, in other embodiments less than 20%, and in other embodiments less than 18% of the diene units are in the vinyl or 1,2 microstructure. In these or other embodiments, the polymer chain is a copolymer wherein greater than 5%, and in other embodiments greater than 10% of the diene mer units are in the vinyl or 1,2 microstructure.

In these or other embodiments, the polymer chain is a copolymer including at least 10%, in other embodiments at least 15%, in other embodiments at least 20%, in other embodiments at least 25%, in other embodiments at least 30%, and in other embodiments at least 40% (on a mole basis) styrene units (i.e., units deriving from the polymerization of styrene). In these or other embodiments, the polymer chain is a copolymer including less than 60% and in other embodiments less than 50% (on a mole basis) styrene mer units. In one or more embodiments, the polymer chain is a homopolymer of conjugated diene, such as polybutadiene, which includes no units deriving from vinyl aromatic monomer or only insubstantial amount of units deriving from vinyl aromatic monomer.

### Hydrogen-Bonding Groups

As indicated above, the polymers having hydrogen-bonding groups (i.e. functionalized polymers) include at least one hydrogen-bonding group, which may also be referred to as hydrogen-bonding functional groups or hydrogen-bonding functionalities. These groups are capable of forming a hydrogen bond with another hydrogen-bonding group of another polymer and/or a hydrogen-bonding group of a modified filler particle. The hydrogen-bonding groups may be complementary, which refers to the fact that distinct functional groups exist on two separate polymer chains, and that these distinct groups interact to form a hydrogen bond. In other embodiments, hydrogen-bonding groups are self-complementary, which refers to the fact that the same functional group exists on two separate polymer chains and these groups interact in a hydrogen bond (which as explained in greater detail below, may occur between distinct hydrogen-bonding sites). In one or more embodiments, these groups are non-terminal and are pendant to the polymer chain. In one or more embodiments, the hydrogen-bonding group does not react with the curative to form covalent crosslinks. Advantageously, under appropriate conditions of compounding and/or curing the polymer composition, a hydrogen-bonding group of one polymer molecule may form a hydrogen bond with a hydrogen-bonding group of a second polymer molecule, thus forming a hydrogen-bonded bridging group between two polymer chains. It should be understood that hydrogen-bonding groups correspond to X or Y of the hydrogen-bonded bridging groups described above.

In one or more embodiments, the polymers (as well as the modified silica further defined herein) having hydrogen-bonding functionalities include a complementary pair of hydrogen-bond donor and hydrogen-bond acceptor groups. For example, one polymer chain may include a hydrogen-bond donor group and another polymer may include a hydrogen-bond acceptor group. In one or more embodiments, hydrogen-bond acceptor groups include, for example, an oxygen or nitrogen atom with a lone electron pair. Examples of hydrogen-bond acceptor groups include, for example, carbonyl, ether, hydroxyl, amino, imino, halide, and nitrile groups. In one or more embodiments, hydrogen bond donor groups include, for example, groups with a hydrogen atom associated with a hydroxyl, amino, or imino group. Examples of hydrogen donor groups include, for example, alcohol, carboxylic acid, amine, imine, amide, imide, and amino acid groups. In one or more embodiments, the polymers having hydrogen-bonding functionalities include two or more hydrogen-bonding groups per polymer chain.

In one or more embodiments, the hydrogen-bonding groups include at least one hydrogen-bonding site, which is a portion or substituent of the group that takes part in the hydrogen bonding. In one or more embodiments, the hydrogen-bonding groups include two, in other embodiments three, and in other embodiments four or more hydrogen-bonding sites per hydrogen-binding groups.

In one or more embodiments, the polymers having hydrogen-bonding groups include an array of hydrogen bonding sites. In one or more embodiments, the array may include multiple hydrogen-bond acceptor sites (A). In other embodiments, the array may include multiple hydrogen-bond donor sites (D). And in other embodiments, the array may include one or more hydrogen-bond acceptor sites (A) and one or more hydrogen-bond donor sites (D). For example, hydrogen-bonding functionalities may include an array including two sites such as, but not limited to, AA, AD, DA and DD. In other embodiments, the functionalities may include an array containing three hydrogen-bonding sites such as, but not limited to, AAA, ADA, AAD, DAD, DDA, and DDD. In other embodiments, the functionalities may include array containing four hydrogen-bonding sites such as, but not limited to, AAAA, AADD, DDDD, and so on. Advantageously, the array of hydrogen-bonding sites can increase the strength of the overall hydrogen bond between the polymer chains. The strength of the individual hydrogen bonds and their number, as well as the attractive and repulsive secondary interactions between adjacent A and D sites, contribute to the overall strength of a hydrogen-bonded array.

In one or more embodiments, the pendant functional group includes a linear array of hydrogen bonding sites that is represented by the formula AADD. This array, which may be referred to as a lock and key array, may lead to particularly advantageous hydrogen bonding with minimal repulsive secondary interactions.

A hydrogen-bonded network that is formed by a plurality of functionalized polymers with multiple hydrogen bonding sites located on pendant hydrogen-bonding groups can be understood with reference to FIG. 2. As shown, a plurality of functionalized polymers (Ma) self-assemble via hydrogen-bonded bridging groups between polymer chains to form a network (IIIb), where unshaded squares represent hydrogen donor sites and shaded squares represent hydrogen acceptor sites.

Specific examples of hydrogen-bonding groups that include multiple hydrogen-bonding sites per group include, but are not limited to, ureidopyrimidyl, triazolyl, triazinyl, bisureyl, and imidazolidinyl groups.

The quantity of hydrogen bonding locations on a polymer chain can be quantified based upon the number of hydrogen bonding groups per polymer chain, with the understanding that each group may include multiple hydrogen bonding sites (e.g. ureidopyrimidyl is believed to include four hydrogen-bonding points per ureidopyrimidyl group). In one or more embodiments, the functionalized polymers of the present invention include greater than 1, in other embodiments greater than 3, and in other embodiments greater than 5 hydrogen-bonding groups per polymer chain. In these or other embodiments, the functionalized polymers of the present invention include from about 1 to about 15, in other embodiments from about 3 to about 12, and in other embodiments from about 5 to about 10 hydrogen-bonding groups per polymer chain.

Preparation of Polymer with Hydrogen-Bonding Functionalities

In one or more embodiments, the polymers with hydrogen-bonding functionalities are prepared by reacting the unsaturated polymer with an enophilic functionalizing agent, which includes at least one group that will react with a double bond of the polymer and at least one group that includes a hydrogen-bonding site. In one or more embodiments, the reaction between the enophilic functionalizing agent and the polymer is a covalent reaction that forms a covalent bond between the enophilic functionalizing agent and the polymer chain.

In one or more embodiments, the enophilic functionalizing agent may be represented by the formula

ε-R¹-ω

where ε is an enophilic group, R¹ is a divalent organic group, and co is a group that includes a hydrogen-bonding group.

Enophilic groups (c), which may also be referred to as enophilic moieties (c), include those groups that are capable of reacting with a double bond to form a covalent bond. In one or more embodiments, the enophilic moieties (c) include moieties having carbon-carbon multiple bonds, carbon-heteroatom multiple bonds, and heteroatom-heteroatom multiple bonds. Specific examples of enophilic groups include thiol groups and azo groups.

Examples of divalent organic groups include hydrocarbylene groups or substituted hydrocarbylene groups such as, but not limited to, alkylene, cycloalkylene, substituted alkylene, substituted cycloalkylene, alkenylene, cycloalkenylene, substituted cycloalkenylene, substituted cycloalkenylene, arylene, and substituted arylene groups, with each group preferably containing from 1 carbon atom, or the appropriate minimum number of carbon atoms to form the group, up to about 20 carbon atoms. A substituted hydrocarbylene group is a hydrocarbylene group in which one or more hydrogen atoms have been replaced by a substituent such as an alkyl group. The divalent organic groups may also contain one or more heteroatoms such as, but not limited to, nitrogen, oxygen, boron, silicon, sulfur and phosphorous atoms.

The hydrogen-bonding group (co) includes those groups or hydrogen-bonding sites described above. For example, the hydrogen-bonding group may include at least one hydrogen-bond donor group, a hydrogen-bond acceptor group, or both a hydrogen-bond donor and a hydrogen-bond acceptor. In one or more embodiments, Z includes a linear array of at least one hydrogen bond acceptor group and at least one hydrogen bond donor group. In one or more embodiments, Z includes a linear array of at least two hydrogen bond acceptor groups and at least two hydrogen bond donor groups. In one or more embodiments, Z includes a linear array of hydrogen bonding sites that is represented by the formula AADD. Specific examples of Z groups include ureidopyrimidyl groups, triazolyl groups, triazinyl groups, bisureyl groups, and imidazolidinyl groups.

In one or more embodiments, the functionalizing agent is selected from the group consisting of 4-phenyl-1,2,4-triazoline-3,5-dione and ureidopyrimidinone thiol. Ureidopyrimidyl thiol can be prepared as is known in the art, for example as described in Wong, C. H. et al., Org. Lett. 2006, 8, 1811, Keizer, H. M. et al., EUR. J. ORG. CHEM. 2004, 2004, 2553, and Peng, H. Q. et al., CHEM. EUR. J. 2014, 11699, all of which are incorporated by reference herein.

As suggested above, in one or more embodiments, the functionalizing agent reacts with an elastomer (e.g. diene-based elastomer) to form a grafted copolymer where the pendant functional group extends from the elastomer as a graft. Without wishing to be bound by any particular theory, it is believed that the Z functionality of the functionalizing agent reacts with unsaturation along the backbone of the diene-based elastomer to thereby form a covalent bond that results in pendant functional groups at one or more locations along the backbone of the diene-based elastomer. Since the reaction is believed to take place at the unsaturation within the backbone of the diene-based polymer, the diene-based polymer need not otherwise be reactive. For example, in one or more embodiments, the reaction between the functionalizing agent and the diene-based elastomer takes place while the diene-based elastomer is non-living.

In one or more embodiments, the reaction between the elastomer and the functionalizing agent takes place in solution where at least one of the polymer and the functionalizing agent are dissolved or solvated in an inert solvent such as an organic solvent. In particular embodiments, both the polymer and functionalizing agent are dissolved or solvated in the solvent during the functionalization reaction. The skilled person will be able to readily select an appropriate solvent in which to conduct the reaction. By conducting the functionalization reaction in solution, it is believed that functionalization efficiency is improved over solid-state reactions. Also, the purity of the functionalized polymer relative to the presence of unreacted functionalizing agent (i.e. functionalizing agent not covalently bonded to the polymer) within the final polymer product is also believed to be improved. Regarding the latter, desolventization and/or isolation of the polymer after functionalization is believed to remove at least a portion of the unreacted functionalizing agent. The functionalized polymer, which is no longer dissolved in the solvent after isolation, can then be solid-state mixed. The skilled person can readily determine appropriate isolation and/or desolventization techniques to separate the functionalized polymer from the solvent in which the reaction takes place. In one or more embodiments, solvent washing techniques may be employed to further attempt to extract functionalizing agent not covalently bound to the polymer chain. In one or more embodiments, the amount of unbound functionalizing agent (i.e. that amount not covalently bound to the polymer chain) compared to that amount of functionalizing agent bound to the polymer chain within the final functionalized polymer product can be quantified based upon the weight ratio of covalently bound to non-covalently bound functionalizing agent in the final polymer product (i.e. the polymer product that is ultimately solid-state mixed to form a vulcanizable composition). In one or more embodiments, the weight ratio of covalently bound functionalizing agent to non-covalently bound functionalizing agent in the final polymer product is greater than 3:1, in other embodiments greater than 5:1, and in other embodiments greater than 7:1, and in other embodiments greater than 10:1.

In one or more embodiments, the amount of the functionalizing agent reacted with the polymer chain may be quantified based upon the moles of functionalizing agent introduced per mole of polymer to be functionalized. In one or more embodiments, the functionalization reaction employs greater than 1, in other embodiments greater than 3, and in other embodiments greater than 5 moles of functionalizing agent per mole of polymer. In these or other embodiments, the functionalization reaction employs less than 15, in other embodiments less than 12, and in other embodiments less than 10 moles of functionalizing agent per mole of polymer. In one or more embodiments, the functionalization reaction employs from about 1 to about 15, in other embodiments from about 3 to about 12, and in other embodiments from about 5 to about 10 moles of functionalizing agent per mole of polymer.

In accordance with certain embodiments, one or more of the functionalizing agents react along the unsaturated diene polymer chain at a point greater than 10, in other embodiments greater than 20, and in other embodiments greater than 50 mer units from either the terminus of the polymer chain.

### Vulcanizate System & Vulcanizable Composition

As indicated above, the crosslinked polymer network may be a component of reinforced rubber system, which may also be referred to as a vulcanizate system. In addition to the crosslinked polymer network described herein, the vulcanizate may also include polymer chains that are crosslinked with the crosslinked polymer network but are not hydrogen bonded to the crosslinked polymer network as understood by this invention. As the skilled person will appreciate, these polymer chains may derive from elastomeric polymers that do not include hydrogen-bonding functionalities. The vulcanizate may also include other constituents that known to be included with rubber vulcanizates. These other constituents may be dispersed throughout the vulcanizate network.

As the skilled person appreciates, the vulcanizates are prepare by curing (i.e. vulcanizing) a vulcanizable composition, which may also be referred to as a rubber formulation. In one or more embodiments, the vulcanizable composition that is cured to form the rubber vulcanizates of this invention includes elastomeric polymer including hydrogen-bonding groups and elastomeric polymer that does not include hydrogen-bonding groups. The vulcanizable compositions also include other constituents such as, but not limited to, reinforcing fillers, plasticizers, and curatives. Specific examples of these ingredients include, but not limited to, carbon black, silica, fillers, oils, resins, waxes, metal carboxylates, cure agents and cure coagents, anti-degradants, and metal oxides.

Exemplary elastomeric polymers that are useful in the practice of the present invention, which may also be referred to as rubber polymers or vulcanizable polymers, include polydienes and polydiene copolymers. Specific examples of these polymer include, but are not limited to, polybutadiene, poly(styrene-co-butadiene), polyisoprene, poly(styrene-co-isoprene), and functionalized derivatives thereof. Other polymers that may be included in the polymer sample include neoprene, poly(ethylene-co-propylene), poly(styrene-co-butadiene), poly(ethylene-co-propylene-co-diene), polysulfide rubber, acrylic rubber, urethane rubber, silicone rubber, epichlorohydrin rubber, syndiotactic polybutadiene, and mixtures thereof or with polydienes and polydiene copolymers. These elastomers can have a myriad of macromolecular structures including linear, branched, and star-shaped structures. These elastomers may also include one or more functional units, which typically include heteroatoms tethered to the backbone of the polymer.

In one or more embodiments, useful carbon blacks include furnace blacks, channel blacks, and lamp blacks. More specific examples of carbon blacks include super abrasion furnace blacks, intermediate super abrasion furnace blacks, high abrasion furnace blacks, fast extrusion furnace blacks, fine furnace blacks, semi-reinforcing furnace blacks, medium processing channel blacks, hard processing channel blacks, conducting channel blacks, and acetylene blacks.

In one or more embodiments, suitable silica fillers include precipitated amorphous silica, wet silica (hydrated silicic acid), dry silica (anhydrous silicic acid), fumed silica, calcium silicate, aluminum silicate, calcium aluminum silicate, magnesium silicate, and the like.

In one or more embodiments, the surface area of the silica, as measured by the BET method, may be from about 32 to about 400 m²/g (including 32 m²/g to 400 m²/g), with the range of about 100 m²/g to about 300 m²/g (including 100 m²/g to 300 m²/g) being preferred, and the range of about 150 m²/g to about 220 m²/g (including 150 m²/g to 220 m²/g) being included. In one or more embodiments, the silica may be characterized by a pH of about 5.5 to about 7 or slightly over 7, or in other embodiments from about 5.5 to about 6.8. Some of the commercially available silica fillers that can be used include, but are not limited to, those sold under the tradename Hi-Sil, such as 190, 210, 215, 233, and 243, by PPG Industries, as well as those available from Degussa Corporation (e.g., VN2, VN3), Rhone Poulenc (e.g., Zeosil™ 1165 MP), and J. M. Huber Corporation.

In one or more embodiments, silica coupling agents are included in the vulcanizable composition. As the skilled person appreciates, these compounds include a hydrolyzable silicon moiety (often referred to as a silane) and a moiety that can react with a vulcanizable polymer.

Suitable silica coupling agents include, for example, those containing groups such as alkyl alkoxy, mercapto, blocked mercapto, sulfide-containing (e.g., monosulfide-based alkoxy-containing, disulfide-based alkoxy-containing, tetrasulfide-based alkoxy-containing), amino, vinyl, epoxy, and combinations thereof. In certain embodiments, the silica coupling agent can be added to the rubber composition in the form of a pre-treated silica; a pre-treated silica has been pre-surface treated with a silane prior to being added to the rubber composition.

Non-limiting examples of alkyl alkoxysilanes suitable for use in certain embodiments of the fourth embodiment disclosed herein include, but are not limited to, octyltriethoxysilane, octyltrimethoxysilane, trimethylethoxysilane, cyclohexyltriethoxysilane, isobutyltriethoxy-silane, ethyltrimethoxysilane, cyclohexyl-tributoxysilane, dimethyldiethoxysilane, methyltriethoxysilane, propyltriethoxysilane, hexyltriethoxysilane, heptyltriethoxysilane, nonyltriethoxysilane, decyltriethoxysilane, dodecyltriethoxysilane, tetradecyltriethoxysilane, octadecyltriethoxysilane, methyloctyldiethoxysilane, dimethyldimethoxysilane, methyltrimethoxysilane, propyltrimethoxysilane, hexyltrimethoxysilane, heptyltrimethoxysilane, nonyltrimethoxysilane, decyltrimethoxysilane, dodecyltrimethoxysilane, tetradecyltrimethoxysilane, octadecyl-trimethoxysilane, methyloctyl dimethoxysilane, and mixtures thereof.

Non-limiting examples of bis(trialkoxysilylorgano)polysulfides suitable for use in certain embodiments of the fourth embodiment disclosed herein include bis(trialkoxysilylorgano)disulfides and bis(trialkoxysilylorgano)tetrasulfides. Specific non-limiting examples of bis(trialkoxysilylorgano)disulfides suitable for use in certain exemplary embodiments of the fourth embodiment disclosed herein include, but are not limited to, 3,3′-bis(triethoxysilylpropyl)disulfide, 3,3′-bis(trimethoxysilylpropyl)disulfide, 3,3′-bis(tributoxysilylpropyl)disulfide, 3,3′-bis(tri-t-butoxysilylpropyl)disulfide, 3,3′-bis(trihexoxysilylpropyl)disulfide, 2,2′-bis(dimethylmethoxysilylethyl)disulfide, 3,3′-bis(diphenylcyclohexoxysilylpropyl)disulfide, 3,3′-bis(ethyl-di-sec-butoxysilylpropyl)disulfide, 3,3′-bis(propyldiethoxysilylpropyl)disulfide, 12,12′-bis(triisopropoxysilylpropyl)disulfide, 3,3′-bis(dimethoxyphenylsilyl-2-methylpropyl)disulfide, and mixtures thereof. Non-limiting examples of bis(trialkoxysilylorgano)tetrasulfide silica coupling agents suitable for use in certain embodiments of the fourth embodiment disclosed herein include, but are not limited to, bis(3-triethoxysilylpropyl)tetrasulfide, bis(2-triethoxysilylethyl)tetrasufide, bis(3-trimethoxysilylpropyl)tetrasulfide, 3-trimethoxysilylpropyl-N,N-dimethylthiocarbamoyl tetrasulfide, 3-triethoxysilylpropyl-N,N-dimethylthiocarbamoyl tetrasulfide, 2-triethoxysilyl-N,N-dimethylthiocarbamoyl tetrasulfide, 3-trimethoxysilylpropyl-benzothiazole tetrasulfide, 3-triethoxysilylpropylbenzothiazole tetrasulfide, and mixtures thereof. Sis(3-triethoxysilylpropyl)tetrasulfide is sold under the tradename Si69 by Evonik Degussa Corporation.

Non-limiting examples of mercapto silanes suitable for use in certain embodiments of the fourth embodiment disclosed herein include, but are not limited to, 1-mercaptomethyltriethoxysilane, 2-mercaptoethyltriethoxysilane, 3-mercaptopropyltriethoxysilane, 3-mercaptopropylmethyldiethoxysilane, 2-mercaptoethyltripropoxysilane, 18-mercaptooctadecyldiethoxychlorosilane, and mixtures thereof.

Non-limiting examples of blocked mercapto silanes suitable for use in certain embodiment of the fourth embodiment disclosed herein include, but are not limited to, those described in U.S. Pat. Nos. 6,127,468; 6,204,339; 6,528,673; 6,635,700; 6,649,684; and 6,683,135, the disclosures of which are hereby incorporated by reference. Representative examples of the blocked mercapto silanes for use herein in certain exemplary embodiments disclosed herein include, but are not limited to, 2-triethoxysilyl-1-ethylthioacetate; 2-trimethoxysilyl-1-ethylthioacetate; 2-(methyldimethoxysilyl)-1-ethylthioacetate; 3-trimethoxysilyl-1-propylthioacetate; triethoxysilylmethyl-thioacetate; trimethoxysilylmethylthioacetate; triisopropoxysilylmethylthioacetate; methyldiethoxysilylmethylthioacetate; methyldimethoxysilylmethylthioacetate; methyldiisopropoxysilylmethylthioacetate; dimethylethoxysilylmethylthioacetate; dimethylmethoxysilylmethylthioacetate; dimethylisopropoxysilylmethylthioacetate; 2-triisopropoxysilyl-1-ethylthioacetate; 2-(methyldiethoxysilyl)-1-ethylthioacetate, 2-(methyldiisopropoxysilyl)-1-ethylthioacetate; 2-(dimethylethoxysilyl- 1-ethylthioacetate; 2-(dimethylmethoxysilyl)-1-ethylthioacetate; 2-(dimethylisopropoxysilyl)-1-ethylthioacetate; 3-triethoxysilyl-1-propylthioacetate; 3-triisopropoxysilyl-1-propylthioacetate; 3-methyldiethoxysilyl-1-propyl-thioacetate; 3-methyldimethoxysilyl-1-propylthioacetate; 3-methyldiisopropoxysilyl-1-propylthioacetate; 1-(2-triethoxysilyl-1-ethyl)-4-thioacetylcyclohexane; 1-(2-triethoxysilyl-1-ethyl)-3-thioacetylcyclohexane; 2-triethoxysilyl-5-thioacetylnorbornene; 2-triethoxysilyl-4-thioacetylnorbornene; 2-(2-triethoxysilyl-1-ethyl)-5-thioacetylnorbornene; 2-(2-triethoxy-silyl-1-ethyl)-4-thioacetylnorbornene; 1-(1-oxo-2-thia-5-triethoxysilylphenyl)benzoic acid; 6-triethoxysilyl-1-hexylthioacetate; 1-triethoxysilyl-5-hexylthioacetate; 8-triethoxysilyl-1-octylthioacetate; 1-triethoxysilyl-7-octylthioacetate; 6-triethoxysilyl-1-hexylthioacetate; 1-triethoxysilyl-5-octylthioacetate; 8-trimethoxysilyl-1-octylthioacetate; 1-trimethoxysilyl-7-octylthioacetate; 10-triethoxysilyl-1-decylthioacetate; 1-triethoxysilyl-9-decylthioacetate; 1-triethoxysilyl-2-butylthioacetate; 1-triethoxysilyl-3-butylthioacetate; 1-triethoxysilyl-3-methyl-2-butylthioacetate; 1-triethoxysilyl-3-methyl-3-butylthioacetate; 3-trimethoxysilyl-1-propylthiooctanoate; 3-triethoxysilyl-1-propyl-1-propylthiopalmitate; 3-triethoxysilyl-1-propylthiooctanoate; 3-triethoxysilyl-1-propylthiobenzoate; 3-triethoxysilyl-1-propylthio-2-ethylhexanoate; 3-methyldiacetoxysilyl-1-propylthioacetate; 3-triacetoxysilyl-1-propylthioacetate; 2-methyldiacetoxysilyl-1-ethylthioacetate; 2-triacetoxysilyl-1-ethylthioacetate; 1-methyldiacetoxysilyl-1-ethylthioacetate; 1-triacetoxysilyl-1-ethyl-thioacetate; tris-(3-triethoxysilyl-1-propyl)trithiophosphate; bis-(3-triethoxysilyl-1-propyl)methyldithiophosphonate; bis-(3-triethoxysilyl-1-propyl)ethyldithiophosphonate; 3-triethoxysilyl-1-propyldimethylthiophosphinate; 3-triethoxysilyl-1-propyldiethylthiophosphinate; tris-(3-triethoxysilyl-1-propyl)tetrathiophosphate; bis-(3-triethoxysilyl-1-propyl)methyltrithiophosphonate; bis-(3-triethoxysilyl-1-propyl)ethyltrithiophosphonate; 3-triethoxysilyl-1-propyldimethyldithiophosphinate; 3-triethoxysilyl-1-propyldiethyldithiophosphinate; tris-(3-methyldimethoxysilyl-1-propyl)trithiophosphate; bis-(3-methyldimethoxysilyl-1-propyl)methyldithiophosphonate; bis-(3-methyldimethoxysilyl-1-propyl)-ethyldithiophosphonate; 3-methyldimethoxysilyl-1-propyldimethylthiophosphinate; 3-methyldimethoxysilyl-1-propyldiethylthiophosphinate; 3-triethoxysilyl-1-propylmethylthiosulfate; 3-triethoxysilyl-1-propylmethanethiosulfonate; 3-triethoxysilyl-1-propylethanethiosulfonate; 3-triethoxysilyl-1-propylbenzenethiosulfonate; 3-triethoxysilyl-1-propyltoluenethiosulfonate; 3-triethoxysilyl-1-propylnaphthalenethiosulfonate; 3-triethoxysilyl-1-propylxylenethiosulfonate; triethoxysilylmethylmethylthiosulfate; triethoxysilylmethylmethanethiosulfonate; triethoxysilylmethylethanethiosulfonate; triethoxysilylmethylbenzenethiosulfonate; triethoxysilylmethyltoluenethiosulfonate; triethoxysilylmethylnaphthalenethiosulfonate; triethoxysilylmethylxylenethiosulfonate, and the like. Mixtures of various blocked mercapto silanes can be used. A further example of a suitable blocked mercapto silane for use in certain exemplary embodiments is that sold under the tradename NXT silane (3-octanoylthio-1-propyltriethoxysilane) by Momentive Performance Materials Inc.

In one or more embodiments, plasticizers include oils and solids resins. Useful oils or extenders that may be employed include, but are not limited to, aromatic oils, paraffinic oils, naphthenic oils, vegetable oils other than castor oils, low PCA oils including MES, TDAE, and SRAE, and heavy naphthenic oils. Suitable low PCA oils also include various plant-sourced oils such as can be harvested from vegetables, nuts, and seeds. Non-limiting examples include, but are not limited to, soy or soybean oil, sunflower oil, safflower oil, corn oil, linseed oil, cotton seed oil, rapeseed oil, cashew oil, sesame oil, camellia oil, jojoba oil, macadamia nut oil, coconut oil, and palm oil. As is generally understood in the art, oils refer to those compounds that have a viscosity that is relatively low compared to other constituents of the vulcanizable composition, such as the resins. In one or more embodiments, the resins may be solids with a Tg of greater than about 20° C., and may include, but are not limited to, hydrocarbon resins such as cycloaliphatic resins, aliphatic resins, aromatic resins, terpene resins, and combinations thereof. Useful resins include, but are not limited to, styrene-alkylene block, copolymers, thermoplastic resins such as C₅-based resins, C₅-C₉ teased resins, C₉-based resins, terpene-based resins, terpene-aromatic compound-based resins, rosin-based resins, dicyclopentadiene resins, alkylphenol-based resins, and their partially hydrogenated, resins.

In one or more embodiments, the vulcanizable compositions of this invention include a cure system. The cure system includes a curative, which may also be referred to as a crosslinking agent, rubber curing agent or vulcanizing agents. Curing agents are described in Kirk-Othmer, ENCYCLOPEDIA OF CHEMICAL TECHNOLOGY, Vol. 20, pgs. 365-468, (3^{rd} Ed. 1982), particularly Vulcanization Agents and Auxiliary Materials, pgs. 390-402, and A. Y. Coran, Vulcanization, ENCYCLOPEDIA OF POLYMER SCIENCE AND ENGINEERING, (2^{nd} Ed. 1989), which are incorporated herein by reference. In one or more embodiments, useful cure systems include sulfur or sulfur-based cross-linking agents, organic peroxide-based crosslinking agents, inorganic crosslinking agents, polyamines crosslinking agents, resin crosslinking agents, oxime-based and nitrosamine-based cross-linking agents, and the like. Examples of suitable sulfur crosslinking agents include “rubbermaker's” soluble sulfur; sulfur donating vulcanizing agents, such as an amine disulfide, polymeric polysulfide or sulfur olefin adducts; and insoluble polymeric sulfur. In other embodiments, the crosslinking agents include sulfur and/or sulfur-containing compounds. In other embodiments, the crosslinking agent excludes sulfur and/or sulfur-containing compounds. Vulcanizing agents may be used alone or in combination.

Other ingredients that are typically employed in rubber compounding may also be added to the rubber compositions. These include accelerators, accelerator activators, additional plasticizers, waxes, scorch inhibiting agents, processing aids, zinc oxide, tackifying resins, reinforcing or hardening resins, fatty acids such as stearic acid, peptizers, and antidegradants such as antioxidants and antiozonants.

### Ingredient Amounts

The elastomeric polymer with and without the hydrogen-bonding groups form the total polymeric content of the vulcanizate. In one or more embodiments, greater than 10 wt %, in other embodiments greater than 35 wt %, and in other embodiments greater than 55 wt % of the total polymeric content of the vulcanizate derives from the elastomeric polymer including hydrogen-bonding groups, with the balance deriving from elastomeric polymer without hydrogen-bonding groups. In one or more embodiments, less than 100 wt %, in other embodiments less than 95 wt %, and in other embodiments less than 75 wt % of the total polymeric content of the vulcanizate derives from the elastomeric polymer including hydrogen-bonding groups, with the balance deriving from elastomeric polymer without hydrogen-bonding groups. In one or more embodiments, from about 10 to about 100 wt %, in other embodiments from about 35 to about 95 wt %, and in other embodiments from about 55 to about 75 wt % of the total polymeric content of the vulcanizate derives from the elastomeric polymer including hydrogen-bonding groups, with the balance deriving from elastomeric polymer without hydrogen-bonding groups. The skilled person will appreciate that the amount of rubber (as well as the other constituents of the vulcanizate) will correspond to the amount of the rubber and rubber additives included in the vulcanizable composition.

In one or more embodiments, the vulcanizable compositions include a filler such as carbon black or silica. In one or more embodiments, the vulcanizable compositions include greater than 10 parts by weight (pbw), in other embodiments greater than 35 pbw, and in other embodiments greater than 55 pbw filler (e.g. carbon black and or silica) per one hundred parts by weight of the rubber (phr). In these or other embodiments, the vulcanizable compositions include less than 140 pbw, in other embodiments less than 95 pbw, and in other embodiments less than 75 pbw filler phr. In one or more embodiments, the vulcanizates include from about 10 to about 200 pbw, in other embodiments from about 10 to about 140 pbw, in other embodiments from about 35 to about 95 pbw, in other embodiments from about 40 to about 130 pbw, in other embodiments from about 50 to about 120 pbw, and in other embodiments from about 55 to about 75 pbw filler (e.g. carbon black and or silica) phr. Carbon black and silica may be used in conjunction at a weight ratio of silica to carbon black of from about 0.1:1 to about 30:1, in other embodiments of from about 0.5 to about 20:1, and in other embodiments from about 1:1 to about 10:1.

In one or more embodiments, where silica is used as a filler, the vulcanizable compositions may include silica coupling agent. In one or more embodiments, the vulcanizable compositions may generally include greater than 1, in other embodiments greater than 2, and in other embodiments greater than 3 pbw silica coupling agent phr. In these or other embodiments, the vulcanizable compositions may generally include less than 40, in other embodiments less than 20, and in other embodiments less than 10 pbw silica coupling agent phr. In one or more embodiments, the vulcanizable compositions include from about 1 to about 40 pbw, in other embodiments from about 2 to about 20 pbw, in other embodiments from about 2.5 to about 15 pbw, and in other embodiments from about 3 to about 10 pbw silica coupling agent phr.

In these or other embodiments, the amount of silica coupling agent may be defined relative to the weight of the silica. In one or more embodiments, the amount of silica coupling agent introduced to the silica (either in situ or pre-reacted) is from about 1 to about 25 pbw, in other embodiments from about 2 to about 20 pbw, and in other embodiments from about 3 to about 15 pbw silica coupling agent per one hundred parts by weight of the silica.

The vulcanizable compositions may generally include greater than 5, in other embodiments greater than 10, and in other embodiments greater than 20 pbw plasticizer (e.g. oils and solid resins) phr. In these or other embodiments, the vulcanizable compositions may generally include less than 80, in other embodiments less than 70, and in other embodiments less than 60 pbw plasticizer phr. In one or more embodiments, vulcanizable compositions may generally include from about 5 to about 80, in other embodiments from about 10 to about 70, and in other embodiments from about 20 to about 60 pbw plasticizer phr. In further embodiments, the vulcanizable compositions may include less than 15 pbw, alternatively less than 10 pbw, or less than 5 pbw of liquid plasticizer. In certain embodiments, the vulcanizable compositions are devoid of liquid plasticizer. In alternative embodiments, the vulcanizable compositions may include at least 20 pbw of resin, at least 25 pbw resin or at least 30 pbw resin.

The skilled person will be able to readily select the amount of vulcanizing agents to achieve the level of desired cure. In particular embodiments, sulfur is used as the cure agent. In one or more embodiments, the vulcanizable compositions may include greater than 0.5, in other embodiments greater than 1, and in other embodiments greater than 2 pbw sulfur phr. In these or other embodiments, the vulcanizable compositions may generally include less than 10, in other embodiments less than 7, and in other embodiments less than 5 pbw sulfur phr. In one or more embodiments, the vulcanizable compositions may generally include from about 0.5 to about 10, in other embodiments from about 1 to about 6, and in other embodiments from about 2 to about 4 pbw sulfur phr.

### Modified Silica

As indicated above, additional embodiments of the present invention may include vulcanizates that include silica particles that are modified to include hydrogen-bonding functionalities. These hydrogen-bonding functionalities may be the same as described above with respect to the functionalized polymer. In one or more embodiments, the silica particles are modified in situ during mixing with a rubber polymer by introducing a functionalizing agent to a mixture of rubber polymer and silica. According to aspects of this invention, the functionalizing agent includes a hydrolyzable group and a hydrogen bonding group. It is believed that the hydrolyzable group undergoes hydrolysis in the presence of water, and then the hydrolyzed intermediate reacts with silica via a condensation reaction. In other embodiments, the silica is pre-modified by combining the silica and the functionalizing agent in the appreciable absence of rubber polymer, and the modified silica can be combined with rubber polymer.

### Silica Functionalizing Agents

In one or more embodiments, the functionalizing agent, which may also be referred to as a silica functionalizing agent or hydrolyzable functionalizing agent, may be represented by the formula η-R¹-ω, where η is a hydrolyzable group, R¹ is a bond or divalent organic group, and ω is a group that includes a hydrogen-bonding functionality. R¹ and ω may be defined as above with respect to the enophilic functionalizing agent.

In one or more embodiments, hydrolyzable groups include those groups or substituents that are relatively stable, and therefore remain chemically bonded to their base or parent atom, in non-aqueous environments or environments that are devoid or substantially devoid of water. Once these groups are exposed to water, moisture, or materials containing water or moisture, the hydrolyzable groups or substituents hydrolyze and are thereby cleaved from their base or parent atom. In one or more embodiments, the base or parent atom is a silicon atom or similar group 14 atom.

In one or more embodiments, the hydrolyzable groups, which may also be referred to as hydrolyzable functionalities, may include, for example, a hydrocarbyloxy group (i.e. —OR), hydrocarbyl amino group (i.e. —NR₂), thiohydrocarbyloxy group (i.e. —SR), hydrocarbylphosphinyl group (i.e. —PR₂), hydrocarbylcarboxyl group (i.e. —OC(O)R), or hydroxyl group (—OH), bonded to a silicon atom or similar group 14 atom, where R is a monovalent organic group. In particular, the hydrolyzable functionality includes a hydrocarbyloxy group bonded to a silicon atom (i.e. an alkoxysilane group). Monovalent organic groups may include hydrocarbyl groups or substituted hydrocarbyl groups such as, but not limited to, alkyl, cycloalkyl, substituted cycloalkyl, alkenyl cycloalkenyl, substituted cycloalkenyl, aryl, allyl, substituted aryl, aralkyl, alkaryl, or alkynyl groups. Substituted hydrocarbyl groups include hydrocarbylene groups in which one or more hydrogen atoms have been replaced by a substituent such as an alkyl group. In one or more embodiments, these groups may include from one, or the appropriate minimum number of carbon atoms to form the group, to 20 carbon atoms. These hydrocarbyl groups may contain heteroatoms such as, but not limited to, nitrogen, boron, oxygen, silicon, sulfur, and phosphorus atoms.

In one or more embodiments, the hydrolyzable group may be included within a silyl substituent, which may be represented by the formula

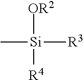

where R² is a hydrocarbyl group, and R³ and R⁴ are each independently a hydrocarbyl group or a hydrocarbyloxy group.

In one or more embodiments, the hydrocarbyl groups of the silyl substituent may include, but are not limited to, alkyl, cycloalkyl, substituted cycloalkyl, alkenyl, cycloalkenyl, substituted cycloalkenyl, aryl, allyl, substituted aryl, aralkyl, alkaryl, or alkynyl groups. Substituted hydrocarbyl groups include hydrocarbyl groups in which one or more hydrogen atoms have been replaced by a substituent such as an alkyl group. In one or more embodiments, the hydrocarbyl groups may include from one, or the appropriate minimum number of carbon atoms to form the group, to 20 carbon atoms. These hydrocarbyl groups may contain heteroatoms such as, but not limited to, nitrogen, boron, oxygen, silicon, sulfur, and phosphorus atoms.

In one or more embodiments, the hydrocarbyloxy groups of the silyl substituent may include, but are not limited to, alkoxy, cycloalkoxy, substituted cycloalkoxy, alkenyloxy, cycloalkenyloxy, substituted cycloalkenyloxy, aryloxy, allyloxy, substituted aryloxy, aralkyloxy, alkaryloxy, or alkynyloxy groups. Substituted hydrocarbyloxy groups include hydrocarbyloxy groups in which one or more hydrogen atoms attached to a carbon atom have been replaced by a substituent such as an alkyl group. In one or more embodiments, the hydrocarbyloxy groups may include from one, or the appropriate minimum number of carbon atoms to form the group, to 20 carbon atoms. The hydrocarbyloxy groups may contain heteroatoms such as, but not limited to nitrogen, boron, oxygen, silicon, sulfur, and phosphorus atoms.

In one or more embodiments, types of silyl substituents may include dihydrocarbyl hydrocarbyloxy silyl groups, hydrocarbyl dihydrocarbyloxy silyl groups, and trihydrocarbyloxy silyl groups.

Specific examples of dihydrocarbyl hydrocarbyloxy silyl groups include, but are not limited to, dimethylmethoxysilyl, diethylethoxysilyl, dipropylethoxysilyl, dibutylethoxysilyl, dipentylethoxysilyl, dihexylethoxysilyl, diheptylethoxysilyl, dioctylethoxysilyl, dipropylethoxysilyl, dibutylethoxysilyl, dipentylethoxysilyl, dihexylethoxysilyl, diheptylethoxysilyl, dioctylethoxysilyl, dimethylmethoxysilyl, diethylmethoxysilyl, dipropylmethoxysilyl, dibutylmethoxysilyl, dipentylmethoxysilyl, dihexylmethoxysilyl, diheptylmethoxysilyl, dioctylmethoxysilyl, dipropylmethoxysilyl, dibutylmethoxysilyl, dipentylmethoxysilyl, dihexylmethoxysilyl, diheptylmethoxysilyl, dioctylmethoxysilyl, dimethylpropoxysilyl, diethylpropoxysilyl, dipropylpropoxysilyl, dibutylpropoxysilyl, dipentylpropoxysilyl, dihexylpropoxysilyl, diheptylpropoxysilyl, dioctylpropoxysilyl, dipropylpropoxysilyl, dibutylpropoxysilyl, dipentylpropoxysilyl, dihexylpropoxysilyl, diheptylpropoxysilyl, dioctylpropoxysilyl, dimethylbutoxysilyl, diethylbutoxysilyl, dipropylbutoxysilyl, dibutylbutoxysilyl, dipentylbutoxysilyl, dihexylbutoxysilyl, diheptylbutoxysilyl, dioctylbutoxysilyl, dipropylbutoxysilyl, dibutylbutoxysilyl, dipentylbutoxysilyl, dihexylbutoxysilyl, diheptylbutoxysilyl, dioctylbutoxysilyl, dimethylphenoxysilyl, diethylphenoxysilyl, dipropylphenoxysilyl, dibutylphenoxysilyl, dipentylphenoxysilyl, dihexylphenoxysilyl, diheptylphenoxysilyl, dioctylphenoxysilyl, dipropylphenoxysilyl, dibutylphenoxysilyl, dipentylphenoxysilyl, dihexylphenoxysilyl, diheptylphenoxysilyl, and dioctylphenoxysilyl groups.

Specific examples of hydrocarbyl dihydrocarbyloxy silyl groups include, but are not limited to, methyldiethyoxysilyl, ethyldiethoxysilyl, propyldiethoxysilyl, butyldiethoxysilyl, pentyldiethoxysilyl, hexyldiethoxysilyl, heptyldiethoxysilyl, octyldiethoxysilyl, propyldiethoxysilyl, butyldiethoxysilyl, pentyldiethoxysilyl, hexyldiethoxysilyl, heptyldiethoxysilyl, octyldiethoxysilyl, methyldimethyoxysilyl, ethyldimethoxysilyl, propyldimethoxysilyl, butyldimethoxysilyl, pentyldimethoxysilyl, hexyldimethoxysilyl, heptyldimethoxysilyl, octyldimethoxysilyl, propyldimethoxysilyl, butyldimethoxysilyl, pentyldimethoxysilyl, hexyldimethoxysilyl, heptyldimethoxysilyl, octyldimethoxysilyl, methyldipropoxysilyl, ethyldipropoxysilyl, propyldipropoxysilyl, butyldipropoxysilyl, pentyldipropoxysilyl, hexyldipropoxysilyl, heptyldipropoxysilyl, octyldipropoxysilyl, propyldipropoxysilyl, butyldipropoxysilyl, pentyldipropoxysilyl, hexyldipropoxysilyl, heptyldipropoxysilyl, octyldipropoxysilyl, methyldibutoxysilyl, ethyldibutoxysilyl, propyldibutoxysilyl, butyldibutoxysilyl, pentyldibutoxysilyl, hexyldibutoxysilyl, heptyldibutoxysilyl, octyldibutoxysilyl, propyldibutoxysilyl, butyldibutoxysilyl, pentyldibutoxysilyl, hexyldibutoxysilyl, heptyldibutoxysilyl, octyldibutoxysilyl, methyldiphenoxysilyl, ethyldiphenoxysilyl, propyldiphenoxysilyl, butyldiphenoxysilyl, pentyldiphenoxysilyl, hexyldiphenoxysilyl, heptyldiphenoxysilyl, octyldiphenoxysilyl, propyldiphenoxysilyl, butyldiphenoxysilyl, pentyldiphenoxysilyl, hexyldiphenoxysilyl, heptyldiphenoxysilyl, and octyldiphenoxysilyl groups.

Specific examples of trihydrocarbyloxy silyl groups include, but are not limited to, trimethyoxysilyl, triethoxysilyl, tripropxysilyl, tributoxysilyl, tripentoxysilyl, trihexoxysilyl, triheptoxysilyl, trioctyloxysilyl, triphenoxysilyl, (methoxy)(diethoxy)silyl, (ethoxy)(dipropoxy)silyl, (propoxy)(diethoxy)silyl, (ethoxy) (diphenoxyl)silyl, (ethoxy)(dipentoxy)silyl, (ethoxy)(propoxy)(butoxy)silyl, (ethoxy)(butoxy)(phenoxy)silyl, and (methoxy)(ethoxy)(phenoxy)silyl groups.

### Preparation op Silica Functionalizing Agent

In one or more embodiments, the silica functionalizing agents may be prepared by employing known synthetic techniques. For example, amine-containing derivatives of compounds including hydrogen-bonding derivatives can be reacted with isocyanate-containing derivatives of compounds including hydrolyzable groups to form the silica functionalizing agents. As a specific example, 2-amino-4-hydroxy-6-methylpyrimidine can be reacted with 3-(trialkoxysilyl)propyl isocyanate under appropriate reaction conditions to yield a ureidopyrimidyl functionalized trialkoxysilane.

### Silica Functionalizing Agent Amounts

In one or more embodiments, the silica functionalizing agent is used as a partial replacement or complete replacement of the silica coupling agent. Accordingly, in certain embodiments, the total loading of silica coupling agents (i.e. conventional coupling agents, which include those coupling agents that are devoid or substantially devoid of hydrogen-bonding units as understood by this invention) and silica functionalizing agents as understood by this invention may be within the amounts specified herein for the silica coupling agent loadings.

In one or more embodiments, the amount of silica functionalizing agent reacted with silica may be defined in terms of the amount of rubber present when the reaction takes place in situ in the presence of the rubber. In one or more embodiments, the vulcanizable compositions may generally include greater than 1, in other embodiments greater than 2, and in other embodiments greater than 3 pbw silica functionalizing agent phr. In these or other embodiments, the vulcanizable compositions may generally include less than 40, in other embodiments less than 20, and in other embodiments less than 10 pbw silica functionalizing agent phr. In one or more embodiments, the vulcanizable composition includes from about 1 to about 40, in other embodiments from about 2 to about 20, in other embodiments from about 2.5 to about 15, and in other embodiments from about 3 to about 10 pbw silica functionalizing agent phr. In one or more embodiments, the vulcanizable compositions are devoid or substantially devoid of silica functionalizing agents (i.e. those with hydrogen-bonding functionalities), where substantially devoid refers to that amount or less that does not appreciably impact the vulcanizable compositions or vulcanizates.

In these or other embodiments, the amount of silica functionalizing agent reacted with silica may be defined relative to the weight of the silica. In one or more embodiments, the vulcanizable compositions may generally include greater than 1, in other embodiments greater than 2, and in other embodiments greater than 3 pbw silica functionalizing agent per 100 parts by weight silica. In these or other embodiments, the vulcanizable compositions may generally include less than 40, in other embodiments less than 20, and in other embodiments less than 10 pbw silica functionalizing agent per 100 parts by weight silica. In one or more embodiments, the amount of silica functionalizing agent introduced to the silica (either in situ or pre-reacted) is from about 1 to about 25 pbw, in other embodiments from about 2 to about 20 pbw, and in other embodiments from about 3 to about 15 pbw silica functionalizing agent per 100 parts by weight silica.

As indicated above, the vulcanizable compositions may include both the silica functionalizing agent defined herein and a conventional silica coupling agent (e.g. a silane not including a hydrogen-bonding functionality as defined herein). When used in combination, the relative amounts may be defined in terms of the weight ratio of the conventional silane (e.g. bis(3-triethoxysilylpropyl)tetrasulfide) relative to the silica functionalizing agent (e.g. ureidopyrimidyl-functionalized silane). In one or more embodiments, the weight ratio of the conventional silane to the silica functionalizing agent may be from about 0.1:1 to about 10:1, in other embodiments from about 0.5:1 to about 5:1, and in other embodiments from about 0.7:1 to about 3:1.

### Preparation of Vulcanizate

In one or more embodiments, the vulcanizate is prepared by vulcanizing a vulcanizable composition, which includes the elastomeric polymers having hydrogen-bonding groups as defined herein. The vulcanizable compositions are otherwise prepared using conventional mixing techniques. The vulcanizable composition is then formed into a green vulcanizate and then subjected to conditions to effect curing (i.e. crosslinking) of the polymeric network. It is believed that at some point during the mixing or curing process, hydrogen bonds are formed between hydrogen-bonding functional groups to form hydrogen-bonded bridging groups between the polymer chains, and/or between modified silica particles, and/or between modified silica parties and polymer chains.

For example, all ingredients of the vulcanizable compositions can be mixed with standard mixing equipment such as Banbury or Brabender mixers, extruders, kneaders, and two-rolled mills. In one or more embodiments, this may include a multi-stage mixing procedure where the ingredients are introduced and/or mixed in two or more stages. For example, in a first stage (which is often referred to as a masterbatch mixing stage), the elastomer (including functionalized polymers of this invention), filler and optional ingredients are mixed. In one or more embodiments, where a silica functionalizing agent pursuant to this invention (i.e. including hydrogen-bonding functionalities) is included in the vulcanizable composition, the silica functionalizing agent is added in one or more masterbatch stages. Likewise, where a silica coupling agent (i.e. conventional type silica coupling agent) is used, either alone or in conjunction with the silica functionalizing agent, it too may be added during one or more masterbatch stages. Generally speaking, masterbatch mixing steps include those steps where an ingredient is added and mixing conditions take place at energies (e.g. temperature and shear) above that which would scorch the composition in the presence of a curative. Similarly, re-mill mixing stages take place at the same or similar energies except an ingredient is not added during a re-mill mixing stage. It is believed that the energies imparted to the vulcanizable composition during masterbatch or re-mill mixing is sufficient to disperse the filler and to cause hydrolysis and subsequent condensation of the hydrolyzable groups. For example, it is believed that during one or more of these mix stages, the hydrolyzable groups of the silica functionalizing agents hydrolyze and then, via a condensation reaction, bond to the silica particles. To this end, in one or more embodiments, masterbatch or re-mill mixing may take place in presence of a catalyst that serves to promote the reaction between the hydrolyzable groups and the silica (e.g. between the silica functionalizing agent and the silica or between the silica coupling agent and the silica). These catalysts are generally known in the art and include, for example, strong bases such as, but not limited to, alkali metal alkoxides, such as sodium or potassium alkoxide; guanidines, such as triphenylguanidine, diphenylguanidine, di-o-tolylguanidine, N,N,N′,N′-tetramethylguanidine, and the like; and hindered amine bases, such as 1,8-diazabicyclo[5.4.0]undec-7-ene, 1,5-diazabicyclo[4.3.0]non-5-ene, and the like, tertiary amine catalysts, such as N,N-dimethylcyclohexylamine, triethylenediamine, triethylamine, and the like, quaternary ammonium bases, such as tetrabutylammonium hydroxide, and bisaminoethers, such as bis(dimethylaminoethyl)ethers.

Accordingly, masterbatch and re-mill mixing takes place in the absence of the curative and proceed at temperatures above which the curing would otherwise take place if the curative was present. For example, this mixing can take place at temperatures in excess of 120° C., in other embodiments in excess of 130° C., in other embodiments in excess of 140° C., and in other embodiments in excess of 150° C.

Once the masterbatch is prepared, the vulcanizing agents may be introduced and mixed into the masterbatch in a final mixing stage, which is typically conducted at relatively low temperatures so as to reduce the chances of premature vulcanization. For example, this mixing may take place at temperatures below 120° C., in other embodiments below 110° C., in other embodiments below 100° C. Additional mixing stages, sometimes called remills, can be employed between the masterbatch mixing stage and the final mixing stage.

During the curing process, covalently-bonded bridging groups are formed between the polymer chains. Covalently-bonded bridging groups may also be formed between polymer chains and silica coupling agents. The functionalized polymer of this invention may be cured to form covalent crosslinks according to procedures known in the art. In one or more embodiments, a sulfur-based cure system is employed. The sulfur-based cure system is capable of forming monosulfide, disulfide or polysulfide covalently-bonded bridges between two chains, by reaction with unsaturations initially present in said chains. In one or more embodiments, the crosslinking agent includes sulfur, a sulfur-donating compound, a metal oxide, a bismaleimide, or a benzoquinone derivative. Examples of crosslinking agents include sulfur, dimorpholine disulfide, alkyl phenol disulfide, zinc and magnesium oxides, benzoquinone dioxime and m-phenylenebismaleimide. The curing package may further include one or more vulcanization aids, such as accelerators, retardants, synergists, fillers, heat stabilizers, radiation stabilizers, short-stoppers and moderating agents.

The skilled person will be able to readily select the amount of vulcanizing agents to achieve the level of desired cure. Also, the skilled person will be able to readily select the amount of cure accelerators to achieve the level of desired cure.

### Properties of Cured Rubber Systems

In one or more embodiments, the vulcanizates of the present invention include a crosslinked network of elastomeric polymer with both hydrogen-bonded bridges (which may also be referred to as hydrogen-bonding crosslinks) and covalently-bonded bridges (which may also be referred to as covalent crosslinks). Generally, hydrogen-bonded crosslinks are less thermally stable than covalently-bonded crosslinks. The less thermally-stable hydrogen-bonded crosslinks tend to break before the more thermally-stable covalently-bonded crosslinks when the vulcanizate is subjected to heat. In one or more embodiments, hydrogen-bonded crosslinks can re-form within the vulcanizate. Thus, the hydrogen-bonded crosslinks can be characterized as reversible, while the breakage of covalently-bonded crosslinks is irreversible.

Advantageously, in one or more embodiments, vulcanizates of the present invention have improved properties in tire applications, such as rolling resistance and wet traction. The reversibility of the hydrogen-bonded crosslinks provides improved dynamic properties.

In one or more embodiments, vulcanizates of the present invention exhibit increased modulus and toughness, when compared to vulcanizates that do not comprise hydrogen-bonded bridging groups. In one or more embodiments, wet traction and rolling resistance are also improved.

In one or more embodiments, vulcanizates with acceptable and even excellent tensile and dynamic properties are achieved with a lower amount of curatives. In one or more embodiments, acceptable modulus and toughness is achieved, even if the curatives are reduced by 30% by weight, in other embodiments by 40%, or in other embodiments 50%. For example, in one or more embodiments, the modulus and toughness of vulcanizates according to the present invention are comparable to the modulus and toughness of vulcanizates that are cured using twice as much curative.

When the modulus of the vulcanizates are comparable, embodiments of the present invention provide vulcanizates that are characterized by improved rolling resistance, snow traction, and wear resistance, and by comparable wet traction, when compared to vulcanizates that do not comprise hydrogen-bonded bridging groups.

In one or more embodiments, the vulcanizates have a glass transitions temperature (Tg) of less than 20° C., in other embodiments less than 10° C., in other embodiments less than 0° C., in other embodiments less than −10° C., in other embodiments less than −20° C., and in other embodiments less than −30° C.

### INDUSTRIAL APPLICABILITY

In particular embodiments, the vulcanizates of the present invention are useful in tire components. This may include use in tire treads, sidewalls, body plies, inner liners, bead fillers, and abrasion strips. The vulcanizable compositions can be processed into tire components according to ordinary tire manufacturing techniques including standard rubber shaping, molding and curing techniques.

### EXPERIMENTAL

In order to demonstrate the practice of the present invention, the following examples have been prepared and tested. The examples should not, however, be viewed as limiting the scope of the invention. The claims will serve to define the invention.

### Experiment I

### Preparation of SBR

To a two-gallon (approximately 7.5 liter) nitrogen purged reactor equipped with a stirrer was added hexanes (1.44 kg), styrene (0.414 kg of a 32.8 weight % solution of styrene in hexanes), and 1,3-butadiene (2.58 kilograms of a 21.1 weight % solution of 1,3-butadiene in hexanes). The reactor was charged with 2,2-bis(2′-tetrahydrofuryl)propane (1.45 mL of a 1.60 M solution in hexanes) followed by n-butylithium (3.54 ml of a 1.60 M solution in hexanes) and the reactor jacket was heated to 50° C. After 29 minutes, the batch temperature peaked at 64.9° C. After 45 minutes from the temperature peak, the polymer cement was dropped into an isopropyl alcohol (IPA)/2,6-di-tert-butyl-4-methylphenol (BHT) solution (˜4 L of a 0.002 g BHT/mL IPA solution), and then drum dried. The poly(styrene-co-butadiene) copolymer (SBR) was characterized and the data is compiled in Table I.

### Synthesis of Ureidopyrimidyl Thiol

Ethyl 4-ethyl-3-oxooctanoate was prepared as follows. To a 2-L oven-dried 3-necked round bottom flask equipped with a stirbar and under Ar was charged potassium ethyl malonate (150 g, 0.880 mol) in anhydrous acetonitrile (1.4 L). The solution was cooled in an ice bath and triethylamine (132 mL, 0.948 mol) was added dropwise via an addition funnel. Anhydrous magnesium chloride (101 g, 1.07 mol) was rapidly added in one portion and the mixture formed a thick suspension, which was allowed to slowly warm to room temperature while stirring overnight. After which, the stirbar was removed and replaced with a mechanical overhead stirrer. After the thick mixture was stirred for 2.5 hours, 2-ethylhexyl chloride (74 mL, 0.43 mol) was added dropwise to the suspension over 30 minutes via an addition funnel. After stirring overnight at room temperature, the resulting tan slurry was concentrated in vacuo, suspended in toluene (700 mL), and treated with aqueous HCl until all the solid material had dissolved. The aqueous and organic layers were separated and the organic layer was washed with 1.6 M HCl (300 mL) followed by sat. aq. NaHCO₃ (500 mL), dried over Na₂SO₄ and concentrated in vacuo to afford ethyl 4-ethyl-3-oxooctanoate as a light yellow tinted oil (84.3 g, 92.0% yield). GC/MS consistent with product.

The ethyl 4-ethyl-3-oxooctanoate (50.0 g, 0.233 mol) in absolute ethanol (300 mL) was charged to a 1-L round bottom flask and then guanidine carbonate (49.8 g, 0.560 mol) was added. The flask was equipped with a Soxhlet extractor and condenser; the Soxhlet thimble was charged with activated 3 Å molecular sieves (38 g). The suspension was refluxed for a total of 28 hours. The suspension was filtered and the resulting eluent was concentrated in vacuo to afford a golden oil, which was re-dissolved in CHCl₃ (500 mL). The resulting solution was washed with sat. aq. NaHCO₃ (200 mL), dried over MgSO₄, and concentrated in vacuo to afford a golden oil. Treatment with pentane (400 mL) resulted in the golden oil precipitating to afford an off-white solid. After filtration and air-drying, 6-(1-ethylpentyl)-isocytosine was isolated as an off-white solid (30.89 g, 63.3% yield). ¹H NMR (300 MHz, CDCl₃) δ 11.6-10.6 (br s, 1H), 7.2-6.8 (br s, 2H), 5.5 (1H), 2.2 (1H), 1.5 (4H), 1.2 (4H), 0.8 (6H); ¹³C NMR (75 MHz, CDCl₃) δ 156.7, 101.5, 47.5, 33.3, 29.5, 26.8, 22.7, 13.9, 11.8.

The 6-(1-ethylpentyl)-isocytosine (2.00 g, 9.56 mmol) was charged to a 100 mL round bottom flask (2.00 g, 9.56 mmol), and 1,1′-carbonyldiimidazole (1.70 g, 10.5 mmol) and anhydrous CH₂Cl₂ (12 mL) were added. After stirring for 4 hours at room temperature, CH₂Cl₂ (26 mL), cystamine dihydrochloride (0.97 g, 4.3 mmol), and triethylamine (1.33 mL, 9.56 mmol) was added to the reaction mixture. After stirring for 19 hours at room temperature, the reaction mixture was poured onto 2 M HCl (40 mL) in a separatory funnel and diluted with CH₂Cl₂ (100 mL). The layers were separated and the organic layer was washed with sat. aq. NaHCO₃ (40 mL) then sat. aq. NaCl (40 mL), dried over Na₂SO₄, filtered, and concentrated in vacuo to afford an off-white solid. The crude residue was purified by flash chromatography using a gradient of 1% MeOH/CH₂Cl₂ to 7% MeOH/CH₂Cl₂ (Rf=0.33 with 5% MeOH/CH₂Cl₂) to afford the bisureidopyrimidinone disulfide as a white solid (2.44 g, 91.1% yield). Analytical data consistent with product.

The bisureidopyrimidinone disulfide (8.47 g, 13.6 mmol) was charged to a 1 L round bottom flask with DL-dithiothreitol (6.29 g, 40.8 mmol) in anhydrous CH₂Cl₂ (500 mL) and 1,8-diazabicyclo[5.4.0]undec-7-ene (0.91 mL, 6.1 mmol). After stirring for 1.5 hours at room temperature, TLC indicated the reaction was complete (Product Rf=0.44 with 5% MeOH/CH₂Cl₂) and the reaction mixture was poured into a separatory funnel and washed with water (3×100 mL). The organic mixture was dried over Na₂SO₄, filtered, and concentrated in vacuo to afford a viscous oil that was immediately re-dissolved in toluene to make a 0.45 M solution and carried on without further purification. Analytical data was consistent with ureidopyrimidyl thiol.

### Preparation of Functionalized SBR

Using the SBR and ureidopyrimidyl thiol prepared above, SBR with a grafted ureidopyrimidyl group was prepared according to the following procedure. To six large bottles, each charged with styrene-butadiene rubber (SBR, 50 g each bottle) re-dissolved in toluene (460 mL each bottle), was added ureidopyrimidyl thiol (2.5 mL of a 0.90 M solution in toluene, 2.3 mmol each bottle) and 2,2′-azobis-(2-methylpropionitrile) (1.8 mL of a 0.125 M solution in toluene, 0.23 mmol each bottle). After agitating the bottles in an 80° C. water bath for 4 hours, additional charges of ureidopyrimidyl thiol (2.5 mL of a 0.90 M solution in toluene, 2.3 mmol each bottle) and 2,2′-azobis-(2-methylpropionitrile) (1.8 mL of a 0.125 M solution in toluene, 0.23 mmol each bottle) were added and the bottles were returned to an 80° C. bath for further agitation. After agitating in an 80° C. water bath for 16 hours, the bottles were removed, vented, quenched with an IPA/BHT solution (3 mL of a 0.115 g BHT/mL IPA solution), combined and coagulated in an IPA/BHT solution (˜4 L of a 0.002 g BHT/mL IPA solution), and then drum dried. Both the SBR and the resultant functionalized polymer (ureidopyrimidyl-grafted SBR) were analyzed and the results of the analysis are set forth in Table I.

TABLE I

| | | Ureidopyrimidyl- |
|---|---|---|
| Polymer Type | SBR | grafted SBR |
| GPC | | |
| Peak 1 | | |
| Mn (SBR Std; kg/mol) | 108 | 104 |
| Mp (SBR Std; kg/mol) | 112 | 114 |
| MWD (SBR Std) | 1.05 | 1.08 |
| Mp (PS Std; kg/mol) | 187 | 190 |

Peak 2

| | | |
|---|---|---|
| Mn (SBR Std; kg/mol) | N/A | 312 |
| Mp (SBR Std; kg/mol) | N/A | 214 |
| MWD (SBR Std) | N/A | 1.39 |
| Mp (PS Std; kg/mol) | N/A | 361 |
| % Peak 2 | N/A | 48% |
| Nitrogen Content (ppm) | 15 | 2351 |
| Ureidopyrimidyl per Chain | N/A | 4.7 |

NMR

| | | |
|---|---|---|
| Sty mol (%) | 11.9 | 12.4 |
| Sty mol (%) | 39.5 | 39.0 |
| 1,2-BD mol (%) | 48.6 | 48.3 |
| Ureidopyrimidyl mol (%) | N/A | 0.31 |

The number average molecular weight (Mn), weight average molecular weight (Mw), and peak molecular weights (Mp) were determined by using gel permeation chromatography (GPC) calibrated with appropriate standards (as indicated) and adjusted for the Mark-Houwink constants for the polymer in question. Where the standard is not specifically indicated, polystyrene standards were used.

### Preparation of Vulcanizable Compositions

Vulcanizable compositions were prepared from the polymers identified in Table I using the rubber formulation and mixing order provided in Table II. This rubber formulation was indicative of a rubber formulation that is useful in the manufacture of tire treads. As shown in Table II, the mix procedure was a two-step mix procedure including a masterbatch mix step and a final mix step. The mixing steps were performed within a Brabender mixer. During preparation of the masterbatch, the mixer was operated at 60 rpm and a peak compositional temperature of 160° C. was attained. At that point in time, the composition was dropped from the mixer and allowed to cool to below about 50° C. Then, the composition was again reintroduced to the mixer along with the ingredients identified for the final mix stage. Mixing was continued at 40 rpm at a peak compositional temperature of about 100° C. The composition was then dropped from the mixer.

TABLE II

| | Weight Parts |
|---|---|
| Masterbatch | |
| Rubber Polymer | 100 |
| Silica | 55 |
| Oil | 10 |
| Stearic Acid | 2 |
| Wax | 2 |
| Antioxidant | 1 |
| Zinc Oxide | 2.5 |
| Silane | 5 |
| Final | |
| Sulfur | 1.5 |
| Benzothiazole accelerator I | 0.7 |
| Benzothiazole accelerator II | 2.0 |
| Organic base | 1.4 |

Samples were obtained from the final composition and fabricated into test samples for purposes of the analytical testing. The results of the analytical testing are provided in Table III.

TABLE III

| Sample Identifier | Control | Sample 1 |
|---|---|---|
| Polymer Type | SBR | Ureidopyrimidyl-grafted SBR |

Tensile Properties @ 23° C.

| | | |
|---|---|---|
| 50% Mod (MPa) | 1.85 | 2.01 |
| 100% Mod (MPa) | 3.25 | 3.56 |
| 200% Mod (MPa) | 6.14 | 8.66 |
| Max. Strain (MPa) | 7.74 | 10.6 |
| Max. Strain (%) | 227 | 211 |

Rheological Data

| | | |
|---|---|---|
| Tan δ (0° C.) | 0.386 | 0.498 |
| Tan δ (60° C.) | 0.133 | 0.0661 |
| Wet μ (23° C.) | 1.643 | 1.648 |

The tensile mechanical properties (Max Stress, Modulus, Elongation, and Toughness) of the vulcanizates were measured by using the standard procedure described in ASTM-D412. The dynamic rheological properties (e.g. tan 6) of the vulcanizates were obtained from temperature-sweep studies, which were conducted over the range from about −80° C. to about 80° C. and 10 Hz. Wet μ was measured at room temperature by Nanovea tribometer in pin-on-disk mode on 1000 grit sandpaper.

### Experiment II

### Preparation of Ureidopyrimidyl-Grafted SBR

Poly(styrene-co-butadiene) (SBR) and ureidopyrimidinone thiol were prepared in a manner as described above with respect to Experiment I and used to prepare ureidopyrimidyl-grafted SBR as follows. To six large bottles, each charged with styrene-butadiene rubber (SBR: 20.8% Styrene, 51.6% vinyl [based on BD=100], Mn=108 kg/mol [SSR std]; 50 g each bottle) re-dissolved in toluene (460 mL each bottle), was added ureidopyrimidyl thiol (3.0 mL of a 0.77 M solution in toluene, 2.3 mmol each bottle) and 2,2′-azobis-(2-methylpropionitrile) (1.9 mL of a 0.123 M solution in toluene, 0.23 mmol each bottle). After agitating the bottles in a 65° C. water bath for 20 hours, the bottles were removed, vented, quenched with an IPA/BHT solution (3 mL of a 0.115 g BHT/mL IPA solution), combined and coagulated in an IPA/BHT solution (˜4 L of a 0.002 g BHT/mL IPA solution), and then drum dried to afford ureidopyrimidyl-grafted SBR (273 g). The polymer was characterized and the data is compiled in Table IV.

### Preparation of Phenyl-1,2,4-Triazoline-3,5-Dione-Grafted SBR—Sample 2C

The SBR prepared above was also used to prepare SBR with grafted with 4-phenyl-1,2,4-triazoline-3,5-dione according to the following. To a large glass bottle charged with styrene-butadiene rubber (SBR, 55 g) re-dissolved in THF (total solution volume 350 mL) was added a solution of 4-phenyl-1,2,4-triazoline-3,5-dione (9.1 mL of a 0.30 M solution in THF, 2.7 mmol). After agitation at room temperature for 20.5 hours, the polymer cement was treated with an IPA/BHT solution (3 mL of a 0.115 g BHT/mL IPA solution), coagulated in an IPA/BHT solution (˜4 L of a 0.002 g BHT/mL IPA solution), and drum dried to afford triazolyl-grafted SBR (53.7 g). The polymer was characterized and the data is compiled in Table IV.

### Preparation of Phenyl-1,2,4-Triazoline-3-5-Dione-Grafted SBR—Sample 2D

Similarly, the SBR was used to prepare triazolyl-grafted SBR as follows. To a large glass bottle charged with styrene-butadiene rubber (SBR, 55 g) re-dissolved in THF (total solution volume 350 mL) was added a solution of 4-phenyl-1,2,4-triazoline-3,5-dione (18.1 mL of a 0.3 M solution in THF). After agitation at room temperature for 20.5 hours, the polymer cement was treated with an IPA/BHT solution (3 mL of a 0.115 g BHT/mL IPA solution), coagulated in an IPA/BHT solution (˜4 L of a 0.002 g BHT/mL IPA solution), and drum dried to afford triazolyl-grafted SBR (52.9 g). See Table 1 for polymer characterization. The polymer could not be dissolved in standard organic solvents limiting the characterization compiled in Table IV.

TABLE IV

| | | | | |
|---|---|---|---|---|
| | | Triazolyl- | Triazolyl- | Triazolyl- |
| | | grafted | grafted | grafted |
| Polymer Type | SBR | SBR 2B | SBR 2C | SBR 2D |

GPC
Base Peak

| | | | | |
|---|---|---|---|---|
| Mn (SBR Std; kg/mol) | 100 | 107 | 77 | Not Soluble |
| Mw (SBR Std; kg/mol) | 104 | 112 | 96 | Not Soluble |
| Mp (SBR Std; kg/mol) | 104 | 113 | 104 | Not Soluble |
| MWD (SBR Std) | 1.05 | 1.05 | 1.25 | Not Soluble |
| Mn (PS Std; kg/mol) | 167 | 178 | 128 | Not Soluble |
| Mw (PS Std; kg/mol) | 174 | 187 | 160 | Not Soluble |
| Mp (PS Std; kg/mol) | 174 | 189 | 175 | Not Soluble |
| MWD (PS Std) | 1.05 | 1.05 | 1.26 | Not Soluble |

Coupled Peaks

| | | | | |
|---|---|---|---|---|
| Mn (SBR Std; kg/mol) | N/A | 531/216 | 281 | Not Soluble |
| Mw (SBR Std; kg/mol) | N/A | 714/221 | 391 | Not Soluble |
| Mp (SBR Std; kg/mol) | N/A | 290/213 | 188 | Not Soluble |
| MWD (SBR Std) | N/A | 1.34/1.03 | 1.39 | Not Soluble |
| Mn (PS Std; kg/mol) | N/A | 895/362 | 471 | Not Soluble |
| Mw (PS Std; kg/mol) | N/A | 1,207/371 | 659 | Not Soluble |
| Mp (PS Std; kg/mol) | N/A | 487/358 | 315 | Not Soluble |
| MWD (PS Std) | N/A | 1.35/1.03 | 1.40 | Not Soluble |
| % Coupling | N/A | 33%/20% | 31% | Not Soluble |

NMR

| | | | | |
|---|---|---|---|---|
| Wt % Styrene | 20.5% | 21.5% | 21.5% | Not Soluble |
| Wt % 1,2-BD* | 50.7% | 53.6% | 53.2% | Not Soluble |
| Mol % Functionality | N/A | 0.18% | Not | Not Soluble |
| | | | Detected | |
| Avg. Funct. Per Chain | N/A | 3.2 | Not | Not Soluble |
| | | | Determined | |

### Preparation of Vulcanizable Compositions

Vulcanizable compositions were prepared from the polymers identified in Table IV using the rubber formulation and mixing order provided in Table V. This rubber formulation was indicative of a rubber formulation that is useful in the manufacture of tire treads. As shown in Table V, the mix procedure was a two-step mix procedure including a masterbatch mix step and a final mix step. The mixing steps were performed within a Brabender mixer. During preparation of the masterbatch, the mixer was operated at 60 rpm and a peak compositional temperature of 160° C. was attained. At that point in time, the composition was dropped from the mixer and allowed to cool to below about 50° C. Then, the composition was again reintroduced to the mixer along with the ingredients identified for the final mix stage. An additional control compound sample using SBR Sample 2 Å was made by increasing the curatives in the final mix stage by 30% (i.e. ×1.3). Mixing was continued at 40 rpm at with a peak compositional temperature of about 100° C. The composition was then dropped from the mixer.

TABLE V

Weight Parts

Masterbatch

| | |
|---|---|
| Rubber Polymer | 100 |
| Silica | 55 |
| Oil | 10 |
| Stearic Acid | 2 |
| Wax | 2 |
| Antioxidant | 1 |
| Zinc Oxide | 2.5 |
| Silane | 5 |

Final

| | |
|---|---|
| Sulfur | 1.5 |
| Benzothiazole I | 0.7 |
| Benzothiazole II | 2.0 |
| Strong base | 1.4 |

Samples were obtained from the final composition and fabricated into test samples for purposes of the analytical testing. The results of the analytical testing are provided in Table VI.

TABLE VI

| Sample | Control | Control | | | |
|---|---|---|---|---|---|
| Identifier | 2A | 2B | Sample 2 | Sample 3 | Sample 4 |
| Polymer | SBR | SBR | Ureido- | Triazolyl- | Triazolyl- |
| Type | | | pyrimidyl- | grafted | grafted |
| | | | grafted | SBR 2C | SBR 2D |
| | | | SBR 2B | | |

Tensile Properties a 23° C.

| | | | | | |
|---|---|---|---|---|---|
| 50% | 2.71 | 3.57 | 3.22 | 3.62 | 3.98 |
| Mod (MPa) | | | | | |
| 100% | 4.80 | 6.54 | 6.20 | 6.93 | 7.59 |
| Mod (MPa) | | | | | |
| 200% | 9.45 | | | | |
| Mod (MPa) | | | | | |
| Max. | 10.1 | 9.5 | 10.0 | 8.3 | 9.6 |
| Strain | | | | | |
| (MPa) | | | | | |
| Max. | 213.1 | 148.7 | 147.2 | 120.5 | 125.2 |
| Strain (%) | | | | | |

Rheological Data

| | | | | | |
|---|---|---|---|---|---|
| Tan δ@ | 0.390 | 0.415 | 0.419 | 0.384 | 0.402 |
| 0° C. | | | | | |
| Tan δ@ | 0.142 | 0.123 | 0.0770 | 0.105 | 0.0991 |
| 60° C. | | | | | |
| Lab Wear | 148 | 100 | 88 | 119 | 123 |

### Experiment III

### Synthesis of Ureidopyrimidinone Disulfide and SBR

Ureidopyrimidinone disulfide was prepared using the procedures provided above with respect to Experiment I. Likewise, SBR was prepared according to the procedure provided above with respect to Experiment I.

### Preparation of Vulcanizable Compositions

Vulcanizable compositions were prepared by using an SBR polymer prepared above and the rubber formulation and mixing order provided in Table VII. In order to isolate the effects attributed to networks from polymer-polymer crosslink intersections, this rubber formulation does not include any reinforcing filler. As shown in Table VII, the mix procedure was a single-step mix procedure performed within a Brabender mixer. During mixing, the mixer was operated at 60 rpm and a peak compositional temperature of 100° C. was attained. The composition was then dropped from the mixer. As suggested in Table VII and more specifically shown in Table VIII, the amount of total accelerator was varied, although the specific accelerators were proportionally maintained.

TABLE VII

| | Weight Parts |
|---|---|
| Rubber Polymer | 100 |
| Stearic Acid | 2 |
| Antioxidant | 1 |
| Zinc Oxide | 2.5 |
| Sulfur | 1.0 |
| Benzothiazole I | Variable |
| Benzothiazole II | Variable |
| Strong base | 0.467 |
| (Ureidopyrimidyl-S)₂ | Variable |

Samples were obtained from the compositions and fabricated into test samples for purposes of the analytical testing. The results of the analytical testing are provided in Table VIII.

TABLE VIII

| Sample | Control | Control | Comparative | Comparative |
|---|---|---|---|---|
| Identifier | 3A | 3B | 1 | 2 |
| Benzothiazole I | 0.400 | 0.833 | 0.400 | 0.833 |
| Benzothiazole II | 0.800 | 1.667 | 0.800 | 1.667 |
| (Ureidopyrimidyl- | 0 | 0 | 2.430 | 2.430 |
| S)₂ | | | | |
| X-Link Density | 7.06 | 10.0 | 4.29 | 8.32 |
| (Ve) × 10⁻⁵ | | | | |

Crosslink density (X-Link Density (Ve)×10⁻⁵) was determined by solvent swelling method in toluene at room temperature according to ASTM D471.

### Experiment IV

### Synthesis of Ureidopyrimidyl-Functionalized Triethoxysilane

To an oven dried round bottom flask charged with 2-amino-4-hydroxy-6-methylpyrimidine (9.00 g, 71.9 mmol) suspended in anhydrous pyridine (130 mL) was added 3-(triethoxysilyl)propyl isocyanate (22 mL, 89 mmol). The round bottom flask was equipped with a condenser and the reaction mixture was refluxed for 3 hours. The resulting homogeneous reaction mixture was concentrated in-vacuo to provide a white paste, which was rinsed with pentane (3×200 mL) and then dried in a vacuum oven to provide the ureidopyrimidyl-functionalized triethoxysilane (2-(3-(triethoxysyl)propylamino-carbonylamino)-6-methyl-4[1H]pyrimidinone) product as a white solid (22.04 g, 82% yield). ¹H and ¹³C NMR were consistent with literature references.

### Stock SBR

A stock SBR was employed. Typical stock values for this material include an Mw of about 495 kg/mol, an Mn of about 175 kg/mol, an Mp of about 250 kg/mol, a molecular weight distribution of about 2.8, a bound styrene content of about 23.5, a vinyl content of about 8.4, and a Tg of about −62° C.

### Preparation of Vulcanizable Compositions

Vulcanizable compositions were prepared using the SBR and the rubber formulation and mixing order provided in Table IX. As shown in Table IX, the mix procedure was a three-step mix procedure including two masterbatch mix steps and a final mix step. The mixing steps were performed within a Brabender mixer. The masterbatch mix steps occurred at 60 rpm and a peak compositional temperature of about 160° C. was achieved for each step. After each masterbatch mix step, the composition was dropped from the mixer and allowed to cool. Mixing during the final mix was conducted at 40 rpm with a peak compositional temperature of about 100° C. The composition was then dropped from the mixer.

TABLE IX

Weight Parts

Masterbatch I

| | |
|---|---|
| Rubber Polymer | 100 |
| Silica | 52.5 |
| Oil | 10 |
| Stearic Acid | 2 |
| Wax | 2 |
| Antioxidant | 1 |
| Zinc Oxide | 2.5 |

Masterbatch II

| | |
|---|---|
| Silica | 2.5 |
| Silane | variable |
| Ureidopyrimidyl-silane | variable |

Final

| | |
|---|---|
| Sulfur | 2 |
| Benzothiazole accelerator I | 0.93 |
| Benzothiazole accelerator II | 2.66 |
| Organic base | 1.86 |

Samples were obtained from the compositions and fabricated into test samples for purposes of the analytical testing. The results of the analytical testing are provided in Table X.

TABLE X

| | | Sample | Sample |
|---|---|---|---|
| Sample Identifier | Control | 1 | 2 |
| Silane | 5 | 0 | 2.5 |
| Ureidopyrimidyl-Silane | 0 | 5 | 2.5 |

Rheological Data

| | | | |
|---|---|---|---|
| G′ @60° C. (0.25% strain) | 100 | 127 | 122 |
| ΔG′ @60° C. (0.25-14% strain) | 100 | 165 | 140 |
| Tan δ @ 60° C. (0.25% strain) | 100 | 96 | 89 |
| ΔTan δ @ 60° C. (0.25-14% strain) | 100 | 215 | 158 |

### Experiment V

The ureidopyrimidyl-functionalized triethoxysilane synthesized above was also used in this experiment. SBR and corresponding ureidopyrimidyl grafted SBR was prepared using methods as described above.

### Preparation of Vulcanizable Compositions

Vulcanizable compositions were prepared using the SBR and ureidopyrimidyl-grafted SBR and the rubber formulation and mixing order provided in Table XI. As shown in Table XI, the mix procedure was a three-step mix procedure including two masterbatch mix steps and a final mix step. The mixing steps were performed within a Brabender mixer. The masterbatch mix steps occurred at 60 rpm and a peak compositional temperature of about 160° C. was achieved for each step. After each masterbatch mix step, the composition was dropped from the mixer and allowed to cool. Mixing during the final mix was conducted at 40 rpm with a peak compositional temperature of about 100° C. The composition was then dropped from the mixer.

TABLE XI

| | |
|---|---|
| Weight | Weight |
| Parts | Parts |

Masterbatch I

| | | |
|---|---|---|
| Rubber Polymer | 100 | 0 |
| Ureidopyrimidyl-grafted SBR | 0 | 100 |
| Silica | 52.5 | 52.5 |
| Oil | 10 | 10 |
| Stearic Acid | 2 | 2 |
| Wax | 2 | 2 |
| Antioxidant | 1 | 1 |
| Zinc Oxide | 2.5 | 2.5 |

Masterbatch II

| | | |
|---|---|---|
| Silica | 2.5 | 2.5 |
| Silane | 5 | 0 |
| Ureidopyrimidyl-Silane | 0 | 5 |

Final

| | | |
|---|---|---|
| Sulfur | 1.5 | 0.75 |
| Benzothiazole accelerator I | 0.6 | 0.3 |
| Benzothiazole accelerator II | 1.2 | 0.6 |
| Organic base | 0.7 | 0.35 |

Samples were obtained from the compositions and fabricated into test samples for purposes of the analytical testing. The results of the analytical testing are provided in Table XII.

TABLE XII

| | | |
|---|---|---|
| | | Ureidopyrimidyl- |
| | | grafted SBR + |
| Sample Identifier | Control | ureidopyrimidyl-Silane |

Rheological Data

| | | |
|---|---|---|
| G′ @60° C. | 100 | 42 |
| (0.25% strain) | | |
| ΔG′ @60° C. | 100 | 18 |
| (0.25-14% strain) | | |
| Tan δ @ 60° C. | 100 | 103 |
| (0.25% strain) | | |
| ΔTan δ @ 60° C. | 100 | 43 |
| (0.25-14% strain) | | |

Various modifications and alterations that do not depart from the scope and spirit of this invention will become apparent to those skilled in the art. This invention is not to be duly limited to the illustrative embodiments set forth herein.

1. A vulcanizate composition comprising:
a crosslinked network of elastomeric polymer, where the crosslinked network includes hydrogen bonds and covalent bonds.

2. The composition of claim 1, where the hydrogen bonds have a binding constant of greater than 1E3/M.

3. The composition of claim 1, where the crosslinked network has a total crosslink density of greater than 1E-6, and where the crosslink density attributable to hydrogen bonding is greater than 1E-7.

4. The composition of claim 3, where greater than 0.5% of the crosslink density of the crosslink network is attributable to hydrogen bonding.

5. The composition of claim 1, where the Tg of the elastomeric polymer is less than −20° C.

6. A method for forming a functionalized elastomeric polymer having pendant functional groups that are capable of forming hydrogen bonds, the method comprising the steps of:
combining (a) an elastomeric polymer and (b) an enophilic functionalizing agent, where the enophilic functionalizing agent includes:
(i) at least one group that is capable of forming a covalent bond with the elastomeric polymer, and
(ii) at least one moiety that is capable of forming a hydrogen bond, to thereby react the elastomeric polymer and the enophilic functionalizing agent.

7. The method of claim 6, where the enophilic functionalizing agent is defined by the formula
ε-R¹-ω
where ε is an enophilic group, R¹ is a divalent organic group, and ω is a group that includes a hydrogen-bonding group.

8. The method of claim 7, where the hydrogen-bonding group includes a hydrogen-bond donor, a hydrogen-bond acceptor, or both a hydrogen-bond donor and hydrogen-bond acceptor.

9. The method of claim 7, where the hydrogen-bonding group includes a linear array of at least one hydrogen-bond acceptor and at least one hydrogen-bond donor.

10. The method of claim 7, where the hydrogen-bonding group includes a group selected from ureidopyrimidyl groups, triazolyl groups, triazinyl groups, bisureyl groups, and imidazolidinyl groups.

11. The method of claim 6, where said combining takes place in solution.

12. The method of claim 6, further comprising the step of isolating the functionalized elastomeric polymer.

13. The method of claim 6, further comprising the step of introducing the isolated functionalized elastomeric polymer to a vulcanizable composition of matter.

14. (canceled)

15. (canceled)

16. A method for preparing a vulcanizate, the method comprising:
(i) combining an elastomeric polymer, silica, and a silica functionalizing agent, where the silica functionalizing agent includes a hydrolyzable group and a hydrogen-bonding group;
(ii) mixing the elastomeric polymer, silica, and silica functionalizing agent to form a mixture;
(iii) introducing a curative to the mixture to form a vulcanizable composition of matter; and
(iv) subjecting the vulcanizable composition to curing conditions to form a vulcanizate.

17. The method of claim 16, where the silica functionalizing agent is defined by the formula
η-R¹-ω
where η is a hydrolyzable group, R¹ is a bond or divalent organic group, and ω is a group that includes a hydrogen-bonding functionality.

18. The method of claim 16, where the elastomeric polymer includes a polymer having a pendent hydrogen-bonding group.

19. The method of claim 16, where the hydrogen-bonding group includes a group selected from ureidopyrimidyl groups, triazolyl groups, triazinyl groups, bisureyl groups, and imidazolidinyl groups.

20. The method of claim 16, where said step of combining includes combining a silica coupling agent with the elastomeric polymer, silica, and silica functionalizing agent.

21. The method of claim 16, where the mixture includes from about 1 to about 40 parts by weight silica functionalizing agent per 100 parts by weight elastomeric polymer.

22. The method of claim 16, where the mixture includes from about 10 to about 200 parts by weight silica per 100 parts by weight elastomeric polymer.

23. (canceled)

24. (canceled)
